(19) United States
(12) Patent Application Publication
(10) Pub. No.: US 2025/0219337 A1
(43) Pub. Date: Jul. 3, 2025

(54) CONNECTOR ASSEMBLY

(71) Applicant: Japan Aviation Electronics Industry, Limited, Tokyo (JP)

(72) Inventors: Osamu HASHIGUCHI, Tokyo (JP); Keisuke NAKAMURA, Tokyo (JP)

(73) Assignee: Japan Aviation Electronics Industry, Limited, Tokyo (JP)

(21) Appl. No.: 18/926,577

(22) Filed: Oct. 25, 2024

(30) Foreign Application Priority Data
Dec. 28, 2023 (JP) 2023-223415

(51) Int. Cl. H01R 24/50; H01R 9/05; H01R 12/70

(52) U.S. Cl. CPC H01R 24/50; H01R 9/0515; H01R 9/0527; H01R 12/7047

(57) ABSTRACT

A connector assembly comprises a coaxial connector, a fixed member and two fixing members. The coaxial connector comprises an outer terminal and a center terminal. The outer terminal has a flange portion and two projecting portions. The flange portion has a first receiving portion and two second receiving portions. The first receiving portion faces forward in a front-rear direction. The fixed member has a main portion, a first contact portion, at least one spring portion and two second contact portions. Under a connected state where the connector assembly is connected to a substrate, the spring portion presses the second contact portion against the second receiving portion while the second contact portion receives reaction force from the second receiving portion by the pressing of the spring portion. The first contact portion is pressed against the first receiving portion along the front-rear direction by the reaction force under the connected state.

### CROSS REFERENCE TO RELATED APPLICATIONS

This application is based on and claims priority under 35 U.S.C. § 119 to Japanese Patent Applications No. JP 2023-223415 filed Dec. 28, 2023, the contents of which are incorporated herein in their entirety by reference.

### BACKGROUND OF THE INVENTION

This invention relates to a connector assembly which is configured to be connected to a substrate.

For example, JPB 6853655 (Patent Document 1) discloses a connector assembly which is configured to be connected to a substrate.

Referring to FIGS. 34 and 35, a substrate-connector connection structure 900 of Patent Document 1 has a substrate 950 and a connector 910, or a connector assembly 910. Specifically, the connector assembly 910 is connected to the substrate 950. The substrate 950 has a signal pattern 952, or a signal line 952, a first ground layer 954 and a plating layer 956. Specifically, the plating layer 956 is located just below the signal line 952 and is formed at a region including an end surface of the first ground layer 954. The connector assembly 910 comprises a coaxial connector 920 and two screws 930, or fixing members 930. The coaxial connector 920 has a center conductor 922, or a center terminal 922, and an outer conductor 924, or an outer terminal 924. When the connector assembly 910 is connected to the substrate 950, the outer terminal 924 is brought into contact with the plating layer 956 which is electrically connected to the first ground layer 954. By this structure, the substrate-connector connection structure 900 of Patent Document 1 is configured to reduce reflection characteristics of signal propagating between the substrate 950 and the connector assembly 910.

In the substrate-connector connection structure 900 of Patent Document 1, it is difficult for the outer terminal 924 of the coaxial connector 920 to be stably connected to the plating layer 956 of the substrate 950 when the connector assembly 910 is connected to the substrate 950. Accordingly, the substrate-connector connection structure 900 of Patent Document 1 might not make a reliable electrical connection between the outer terminal 924 and the first ground layer 954.

### SUMMARY OF THE INVENTION

It is therefore an object of the present invention to provide a connector assembly which enables an outer terminal of a coaxial connector of the connector assembly to be stably connected to a ground layer of a substrate.

One aspect of the present invention provides a connector assembly configured to be connected to a substrate. The substrate is formed with two passing holes. Each of the passing holes passes through the substrate in an up-down direction. The substrate has an upper surface and a lower surface in the up-down direction. The upper surface of the substrate is formed with a signal line. The signal line is located between the two passing holes in a lateral direction perpendicular to the up-down direction. The lower surface of the substrate is formed with a ground layer. The connector assembly comprises a coaxial connector, a fixed member and two fixing members. The coaxial connector is configured to be attached to a distal end of a coaxial cable. The coaxial connector comprises an outer terminal and a center terminal. The outer terminal has a flange portion and two projecting portions. The flange portion has a first receiving portion and two second receiving portions. The first receiving portion faces forward in a front-rear direction perpendicular to both the up-down direction and the lateral direction. Each of the two second receiving portions faces at least rearward in the front-rear direction. The two projecting portions are apart from each other in the lateral direction. Each of the two projecting portions extends forward in the front-rear direction from the flange portion. The fixed member is made of metal. The fixed member is located below the substrate in the up-down direction under a connected state where the connector assembly is connected to the substrate. The ground layer of the substrate is electrically connected to the first receiving portion of the flange portion via the fixed member under the connected state. The fixed member has a main portion, a first contact portion, at least one spring portion and two second contact portions. The main portion extends in a predetermined plane. The first contact portion is provided at the main portion. The first contact portion is located, at least in part, between the two second contact portions. The spring portion extends from the main portion and is resiliently deformable. The two second contact portions are apart from each other in the lateral direction. At least one of the two second contact portions is supported by the spring portion and is movable in the predetermined plane. Under the connected state, the spring portion presses the second contact portion against the second receiving portion while the second contact portion receives reaction force from the second receiving portion by the pressing of the spring portion. The first contact portion is pressed against the first receiving portion along the front-rear direction by the reaction force under the connected state. Under the connected state, the two fixing members are fixed to the two projecting portions of the outer terminal through the two passing holes, respectively, of the substrate while the two fixing members press the fixed member against the ground layer of the substrate so that the predetermined plane becomes perpendicular to the up-down direction.

The connector assembly of the present invention is configured as follows: under the connected state where the connector assembly is connected to the substrate, the spring portion presses the second contact portion against the second receiving portion while the second contact portion receives the reaction force from the second receiving portion by the pressing of the spring portion; and the first contact portion is pressed against the first receiving portion along the front-rear direction by the reaction force under the connected state. Accordingly, the connector assembly of the present invention is configured so that the fixed member is securely connected to the outer terminal of the coaxial connector. Thus, the ground layer of the substrate is electrically connected to the first receiving portion of the flange portion of the outer terminal via the fixed member in a highly reliable manner when the connector assembly of the present invention is connected to the substrate. In other words, the connector assembly of the present invention enables the outer terminal of the coaxial connector of the connector assembly to be stably connected to the ground layer of the substrate.

An appreciation of the objectives of the present invention and a more complete understanding of its structure may be had by studying the following description of the preferred embodiment and by referring to the accompanying drawings.

### BRIEF DESCRIPTION OF THE DRAWINGS

FIG. 1 is a perspective view showing a structure according to an embodiment of the present invention. In the figure, a connector assembly is under a connected state where the connector assembly is connected to a substrate.

FIG. 2 is another perspective view showing the structure of FIG. 1.

FIG. 3 is a top view showing the structure of FIG. 1.

FIG. 4 is a front view showing the structure of FIG. 1.

FIG. 5 is a cross-sectional view showing the structure of FIG. 4, taken along line A-A.

FIG. 6 is a bottom view showing the structure of FIG. 1. In the figure, a part of the connector assembly is enlarged and illustrated.

FIG. 7 is a side view showing the structure of FIG. 1.

FIG. 8 is an exploded, perspective view showing the structure of FIG. 1. In the figure, a coaxial connector is under a pre-connected state where the coaxial connector is not yet connected to the substrate.

FIG. 9 is another exploded, perspective view showing the structure of FIG. 2. In the figure, the coaxial connector is under the pre-connected state where the coaxial connector is not yet connected to the substrate.

FIG. 10 is a side view showing the coaxial connector which is included in the structure of FIG. 8.

FIG. 11 is a top view showing a fixed member which is included in the structure of FIG. 8.

FIG. 12 is a bottom view showing a first modification of the structure of FIG. 6.

FIG. 13 is a perspective view showing a fixed member which is included in the structure of FIG. 12. In the figure, a spring portion is under an initial state where the spring portion is not resiliently deformed.

FIG. 14 is a top view showing the fixed member of FIG. 13.

FIG. 15 is a bottom view showing a second modification of the structure of FIG. 6.

FIG. 16 is a perspective view showing a fixed member which is included in the structure of FIG. 15. In the figure, a spring portion is under an initial state where the spring portion is not resiliently deformed.

FIG. 17 is a top view showing the fixed member of FIG. 16.

FIG. 18 is a perspective view showing a third modification of the structure of FIG. 1. In the figure, a connector assembly is under a connected state where the connector assembly is connected to a substrate.

FIG. 19 is another perspective view showing the structure of FIG. 18.

FIG. 20 is an exploded, perspective view showing the structure of FIG. 18. In the figure, a coaxial connector is under a pre-connected state where the coaxial connector is not yet connected to the substrate.

FIG. 21 is another exploded, perspective view showing the structure of FIG. 19.

FIG. 22 is a top view showing a fixed member which is included in the structure of FIG. 20.

FIG. 23 is a perspective view showing a fourth modification of the structure of FIG. 1. In the figure, a connector assembly is under a connected state where the connector assembly is connected to a substrate.

FIG. 24 is another perspective view showing the structure of FIG. 23.

FIG. 25 is an exploded, perspective view showing the structure of FIG. 24. In the figure, a coaxial connector is under a pre-connected state where the coaxial connector is not yet connected to the substrate.

FIG. 26 is a side view showing the coaxial connector which is included in the structure of FIG. 23.

FIG. 27 is another perspective view showing the structure of FIG. 24. In the figure, the substrate and fixing members are not attached to the coaxial connector, and the coaxial connector and a fixed member are under a temporary assembly state where the coaxial connector and the fixed member are temporally assembled.

FIG. 28 is a perspective view showing a fifth modification of the structure of FIG. 1. In the figure, a connector assembly is under a connected state where the connector assembly is connected to a substrate.

FIG. 29 is a bottom view showing the structure of FIG. 28. In the figure, a part of the connector assembly is enlarged and illustrated.

FIG. 30 is an exploded, perspective view showing the structure of FIG. 28. In the figure, a coaxial connector is under a pre-connected state where the coaxial connector is not yet connected to the substrate.

FIG. 31 is a side view showing the coaxial connector which is included in the structure of FIG. 28.

FIG. 32 is another side view showing the coaxial connector of FIG. 31.

FIG. 33 is a top view showing a fixed member which is included in the structure of FIG. 30.

FIG. 34 is a perspective view showing a substrate-connector connection structure of Patent Document 1.

FIG. 35 is a cross-sectional view showing a part of the substrate-connector connection structure of FIG. 34.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION

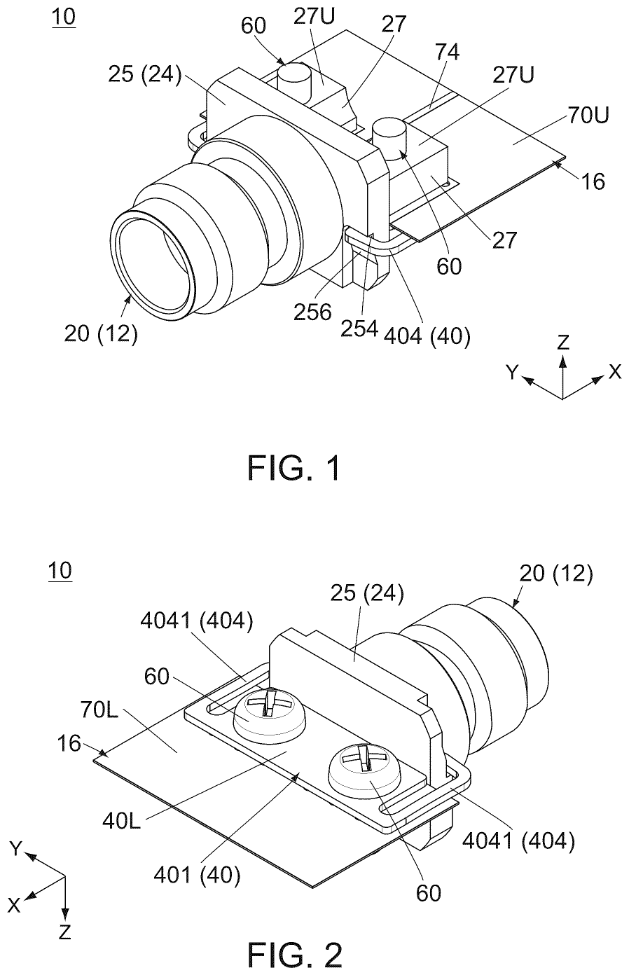

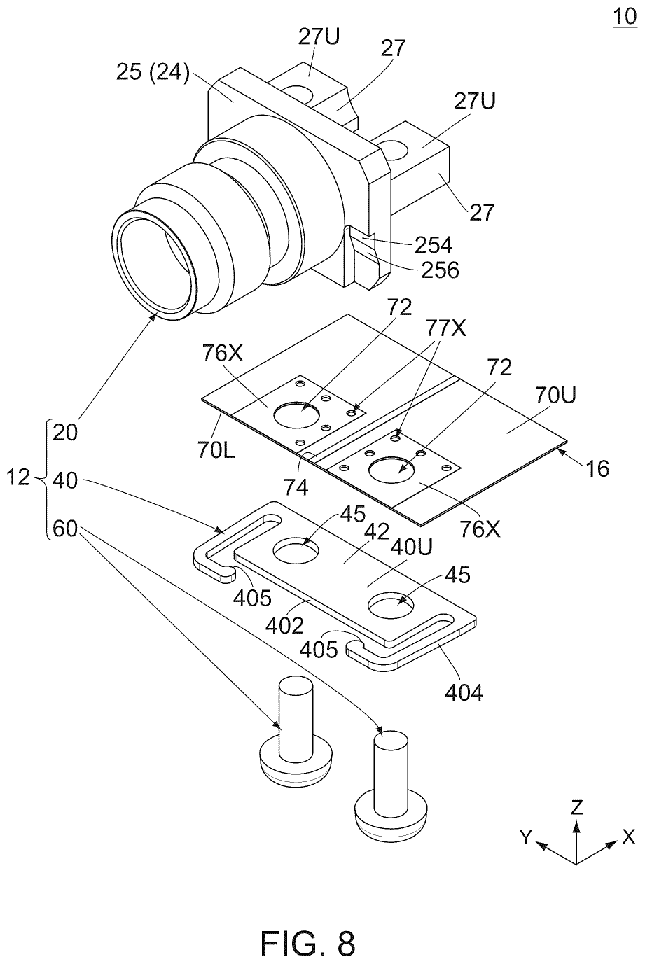

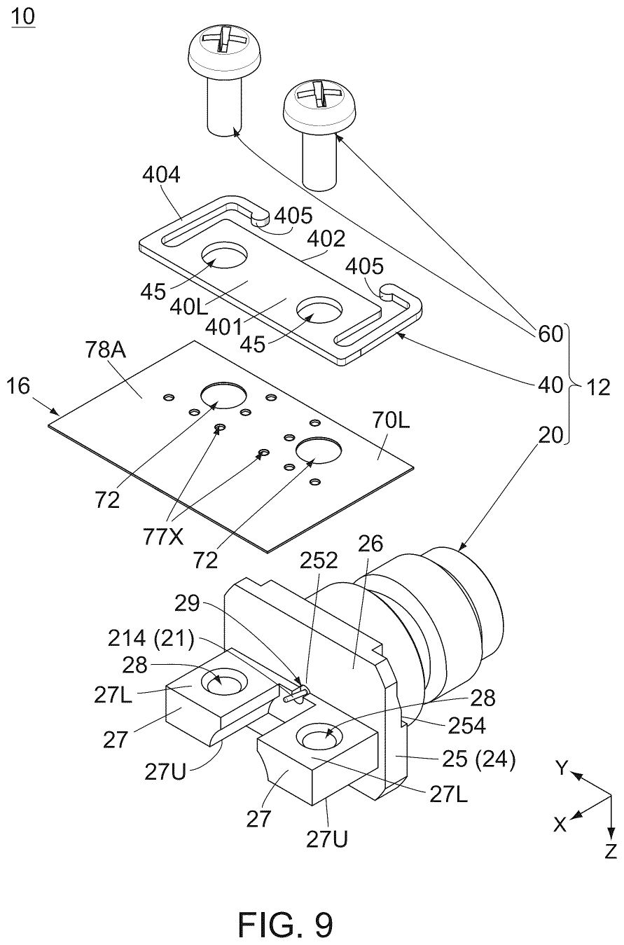

Referring to FIG. 2, a structure 10 according to an embodiment of the present invention comprises a connector assembly 12 and a substrate 16. The substrate 16 extends along a horizontal plane. The connector assembly 12 is configured to be connected to the substrate 16. In detail, the connector assembly 12 is configured to be connected to a rear end portion of the substrate 16 in a front-rear direction parallel to the horizontal plane. The connector assembly 12 of each of FIGS. 1 to 7 is under a connected state where the connector assembly 12 is connected to the substrate 16. In contrast, the connector assembly 12 of each of FIGS. 8 and 9 is under a pre-connected state where the connector assembly 12 is not yet connected to the substrate 16.

The horizontal plane of the present embodiment is an XY-plane. The front-rear direction of the present embodiment is an X-direction. In the present embodiment, “forward” means a positive X-direction, and “rearward” means a negative X-direction. The words such as the horizontal plane and the front-rear direction do not indicate the absolute positional relation relative to the ground but merely indicate a relative positional relation under a definition where the substrate 16 extends in the horizontal plane and where the connector assembly 12 is located rearward of this substrate 16.

Referring to FIGS. 8 and 9, the substrate 16 is not specifically limited. Specifically, the substrate 16 may be a flexible board, or may be a rigid substrate.

As shown in FIGS. 8 and 9, the substrate 16 has an upper surface 70U and a lower surface 70L in an up-down direction perpendicular to the horizontal plane. The upper surface 70U and the lower surface 70L are located at an upper end and a lower end of a base 70, respectively. The up-down direction of the present embodiment is a Z-direction. In the present embodiment, “upward” means a positive Z-direction, and “downward” means a negative Z-direction.

As shown in FIG. 8, the substrate 16 is formed with two passing holes 72. Each of the passing holes 72 passes through the substrate 16 in the up-down direction. Each of the passing holes 72 has a circular shape in the horizontal plane. The thus-formed passing holes 72 are used when the connector assembly 12 is screwed to the substrate 16 as described later. The two passing holes 72 are apart from each other in a lateral direction perpendicular to both the front-rear direction and the up-down direction and are located at positions same as each other in the front-rear direction. The lateral direction of the present embodiment is a Y-direction. In addition, the lateral direction is also referred to as a right-left direction. In the present embodiment, “rightward” means a positive Y-direction, and “leftward” means a negative Y-direction.

The passing holes 72 of the present embodiment are formed as described above. However, the present invention is not limited thereto. For example, the shape of each of the passing holes 72 is not specifically limited. Moreover, the number of the passing holes 72 may be three or more. In this instance, two of the passing holes 72 may be apart from each other in the lateral direction and may be located at positions same as each other in the front-rear direction.

As shown in FIG. 8, the upper surface 70U of the substrate 16 is formed with a signal line 74 which is a conductive pattern. The signal line 74 extends in the front-rear direction and is located between the two passing holes 72 in the lateral direction.

As shown in FIG. 9, the lower surface 70L of the substrate 16 is formed with a ground layer 78A which is a conductive pattern and covers the whole of the lower surface 70L.

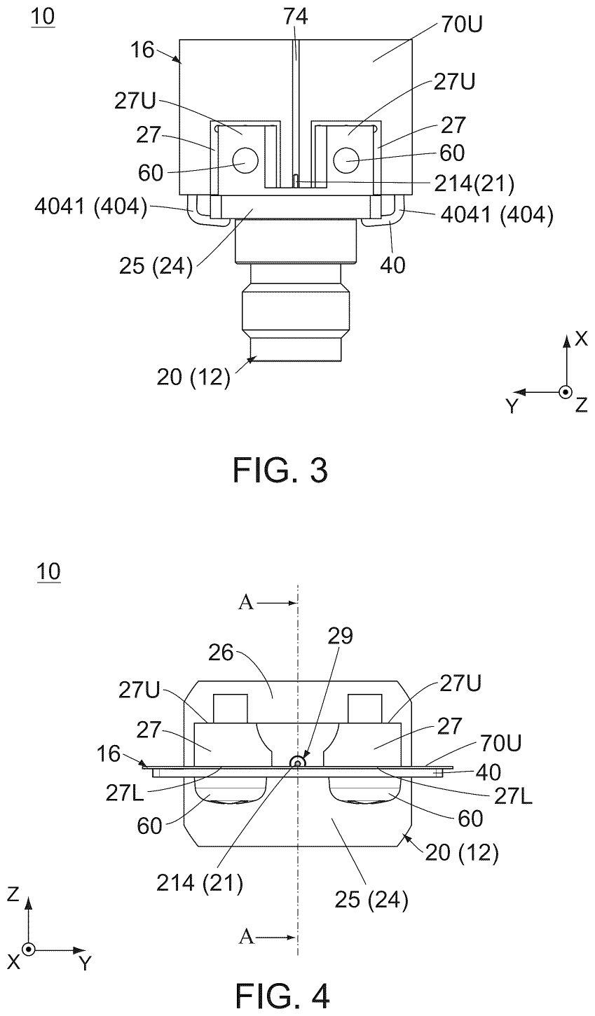

Referring to FIG. 3, the signal line 74 of an instance is connected to an antenna which is formed on an unillustrated front end part of the substrate 16. In this instance, the connector assembly 12 under the connected state transmits signals to the antenna through the signal line 74. The thus-transmitted signals are sent outward from the antenna. On the other hand, signals received by the antenna are transmitted to the connector assembly 12 through the signal line 74. The structure 10 of the present embodiment is uses as described above, for example. In other words, the structure 10 of the present embodiment is an antenna device. However, the usage of the structure 10 of the present invention is not specifically limited. The structure 10 of the present invention may be any electric device with the substrate 16.

As shown in FIG. 8, the substrate 16 comprises two lands 76X each of which is a conductive pattern. The two passing holes 72 pass through the lands 76X, respectively. Each of the lands 76X is formed with a plurality of via holes 77X. Each of the via holes 77X passes through the base 70 and the land 76X in the up-down direction, and thereby each of the lands 76X is electrically connected with the ground layer 78A (see FIG. 9) of the lower surface 70L.

The substrate 16 of the present embodiment has the aforementioned configuration. However, the configuration of the substrate 16 can be modified in accordance with the usage of the structure 10. For example, the ground layer 78A may be partially formed on the lower surface 70L.

Referring to FIG. 9, the connector assembly 12 of the present embodiment comprises a coaxial connector 20, a fixed member 40 and two fixing members 60, or two screws 60. The connector assembly 12 of the present embodiment comprises only the aforementioned members. However, the present invention is not limited thereto. For example, the connector assembly 12 may further comprise another member in addition to the aforementioned members.

Hereafter, explanation will be made about the coaxial connector 20, the fixed member 40 and the fixing members 60 of the present embodiment in this order.

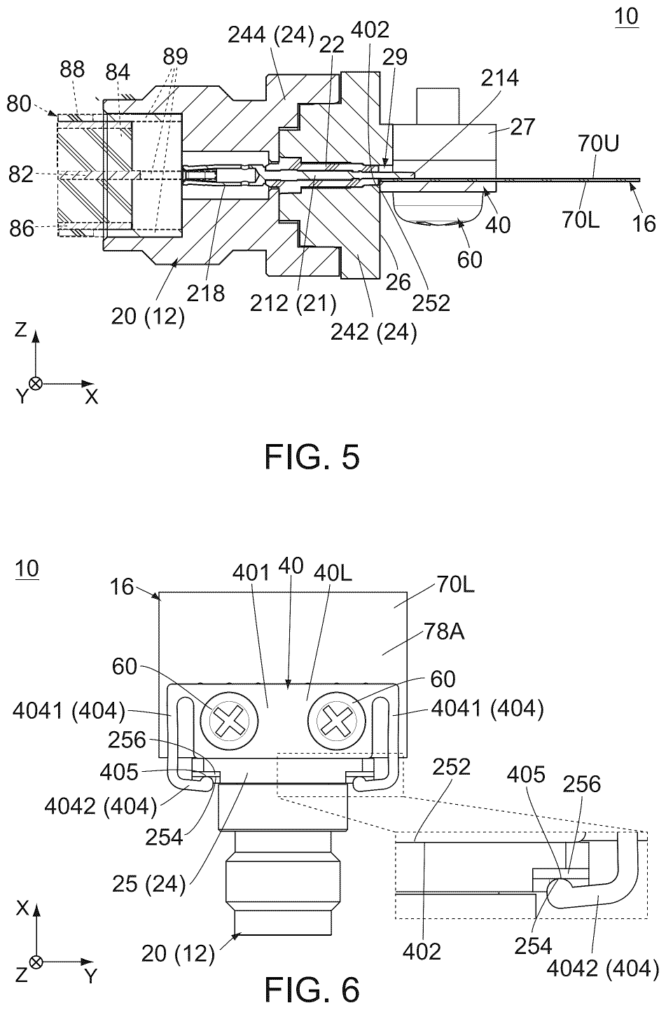

Referring to FIG. 5, the coaxial connector 20 of the present embodiment is configured to be attached to a distal end of a coaxial cable 80. Specifically, the coaxial connector 20 is configured to be attached to a front end of the coaxial cable 80. The coaxial connector 20 of the present embodiment is a so-called sub miniature type A (SMA) connector. However, the present invention is not limited thereto but applicable to various coaxial connectors 20.

Referring to FIG. 5, the coaxial cable 80 illustrated with dashed line is a typical coaxial cable and comprises a center conductor 82 made of conductor, an inner insulator 84 made of insulator and covering the center conductor 82, an outer conductor 86 made of conductor and covering the inner insulator 84 and a sheath 88 made of insulator and covering the outer conductor 86. The number of the center conductor 82 of the present embodiment is one. The configuration of the coaxial connector 20 is not specifically limited, provided that the number of the center conductor 82 is one. For example, the outer conductor 86 may be a braid formed of fine metal wires or may be made of metal foil. For example, the coaxial cable 80 may be connected to a rear end of the coaxial connector 20 via a mating connector 89 attached to the coaxial cable 80.

Referring to FIG. 5, the coaxial connector 20 of the present embodiment comprises a center terminal 21 made of metal and an outer terminal 24 made of metal.

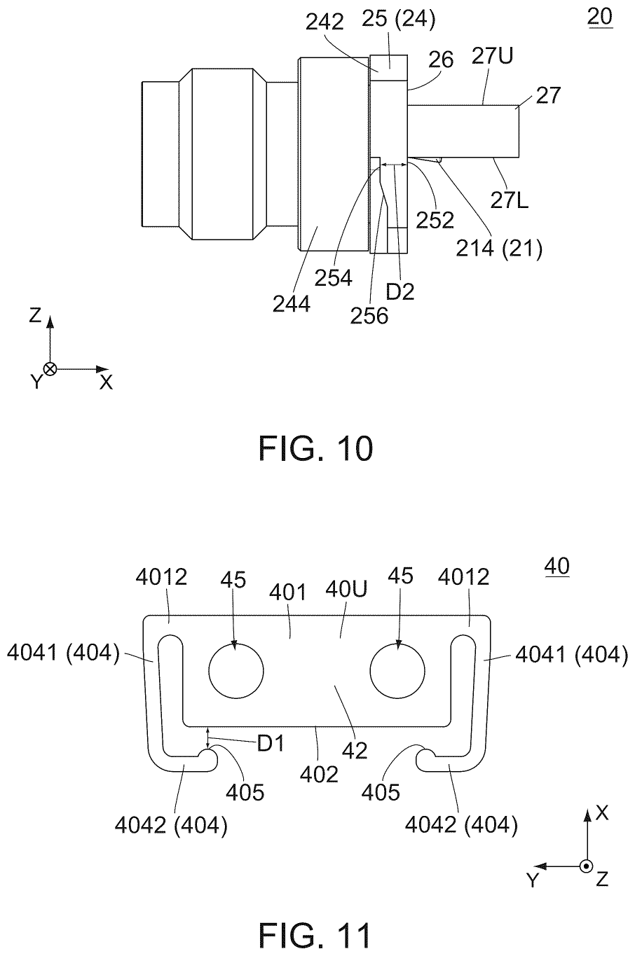

As shown in FIG. 5, the center terminal 21 of the present embodiment extends along the front-rear direction and has a body 212, a contact portion 214 and a connection portion 218. The body 212 is a middle part of the center terminal 21 in the front-rear direction. The contact portion 214 extends forward from the body 212. As shown in FIG. 10, the contact portion 214 is bent downward in the up-down direction after the coaxial connector 20 is assembled. Specifically, the contact portion 214 extends forward and downward under a pre-connected state where the connector assembly 12 is not yet connected to the substrate 16. The contact portion 214 defines a front end of the center terminal 21 in the front-rear direction. As shown in FIG. 5, the connection portion 218 has a socket shape and extends rearward from the body 212. The connection portion 218 defines a rear end of the center terminal 21 in the front-rear direction. The center terminal 21 is connected with the center conductor 82 of the coaxial cable 80 when the coaxial connector 20 is attached to the coaxial cable 80. In detail, the connection portion 218 of the center terminal 21 is configured to be electrically connected with the center conductor 82. The center terminal 21 and the center conductor 82 connected to each other transmit signals to each other.

The center terminal 21 of the present embodiment has the aforementioned configuration. However, the configuration of the center terminal 21 can be modified as necessary, provided that the center terminal 21 has the contact portion 214 which extends along the front-rear direction.

As shown in FIG. 5, the outer terminal 24 of the present embodiment comprises a front conductive member 242 and a rear conductive member 244. The front conductive member 242 is combined with the rear conductive member 244 and is located forward of the rear conductive member 244. The front conductive member 242 is in contact with the rear conductive member 244. The outer terminal 24 of the present embodiment consists of the aforementioned two members. However, the present invention is not limited thereto. For example, the front conductive member 242 and the rear conductive member 244 may be a member integrally formed with each other.

Referring to FIG. 5, the outer terminal 24 is electrically connected with the outer conductor 86 of the coaxial cable 80 when the coaxial connector 20 is attached to the coaxial cable 80. In detail, the rear conductive member 244 of the outer terminal 24 is configured to be electrically connected with the outer conductor 86. The outer terminal 24 and the outer conductor 86 connected to each other have ground potentials same as each other.

As shown in FIG. 9, the outer terminal 24 has a flange portion 25 and two projecting portions 27.

As shown in FIGS. 8 and 9, the flange portion 25 of the present embodiment has a first receiving portion 252 and two second receiving portions 254.

As shown in FIG. 9, the first receiving portion 252 faces forward in the front-rear direction perpendicular to both the up-down direction and the lateral direction. The first receiving portion 252 is located around a middle of the flange portion 25 in the up-down direction. The first receiving portion 252 is located at a middle of the flange portion 25 in the lateral direction. Referring to FIGS. 2 and 9, under the connected state, the ground layer 78A of the substrate 16 is electrically connected to the first receiving portion 252 of the flange portion 25 via the fixed member 40.

As shown in FIG. 6, each of the two second receiving portions 254 faces rearward in the front-rear direction. However, the present invention is not limited thereto. The second receiving portion 254 may face rearward in the front-rear direction and outward in the lateral direction. In other words, each of the two second receiving portions 254 should face at least rearward in the front-rear direction. The second receiving portions 254 are located at opposite ends, respectively, of the flange portion 25 in the lateral direction.

As shown in FIG. 10, the first receiving portion 252 is located forward of any of the second receiving portions 254 in the front-rear direction. However, the present invention is not limited thereto. The first receiving portion 252 may be located rearward of the second receiving portion 254 in the front-rear direction, provided that the first receiving portion 252 faces forward while the second receiving portion 254 faces at least rearward. If the first receiving portion 252 and the second receiving portions 254 are configured similar to the present embodiment, the flange portion 25 can have a reduced size in the front-rear direction. Accordingly, the first receiving portion 252 and the second receiving portions 254 of the present embodiment are more preferable. The flange portion 25 has a second distance D2 between the first receiving portion 252 and any of the second receiving portions 254 in the front-rear direction.

Referring to FIG. 8, the flange portion 25 of the present embodiment has two guide portions 256. Each of the guide portion 256 is oblique to both the front-rear direction and the up-down direction. The guide portion 256 is located below the second receiving portion 254 in the up-down direction. The guide portions 256 correspond to the second receiving portions 254, respectively. Each of the guide portions 256 is located below the corresponding second receiving portion 254 in the up-down direction.

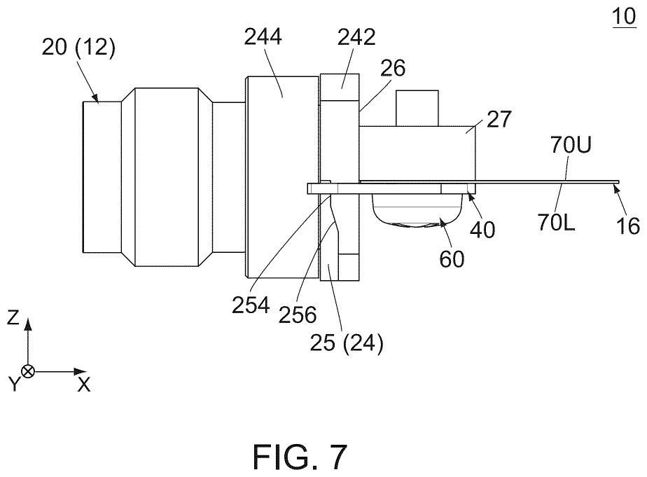

As shown in FIG. 9, the two projecting portions 27 of the present embodiment are apart from each other in the lateral direction. The contact portion 214 is located between the two projecting portions 27 in the lateral direction. Each of the two projecting portions 27 extends forward in the front-rear direction from the flange portion 25. The two projecting portions 27 of the present embodiment have a mirror symmetric shape with respect to a predetermined plane, or to an XZ-plane. The thus-arranged two projecting portions 27 are located at positions same as each other in the up-down direction. Each of the two projecting portions 27 has an upper surface 27U and a lower surface 27L in the up-down direction. Each of the upper surface 27U and the lower surface 27L is a flat surface in parallel to the horizontal plane. The upper surface 27U defines an upper end of the projecting portion 27 in the up-down direction. The lower surface 27L defines an lower end of the projecting portion 27 in the up-down direction. As shown in FIG. 10, a lower end of the contact portion 214 is located downward of the lower surface 27L of the projecting portion 27 under the pre-connected state. Referring to FIGS. 7, 8 and 9, the outer terminal 24 is grounded to the ground layer 78A of the substrate 16 via the projecting portions 27 and the lands 76X under the connected state.

As shown in FIG. 9, each of the projecting portions 27 of the present embodiment is formed with a screw hole 28. Each of the screw holes 28 of the present embodiment passes through the projecting portion 27 in the up-down direction. The screw holes 28 are provided at positions which correspond to those of the passing holes 72, respectively, of the substrate 16 in the horizontal plane. Specifically, the two screw holes 28 are apart from each other in the lateral direction and are located at positions same as each other in the front-rear direction. The number of the screw holes 28 of the present embodiment is two. However, the present invention is not limited thereto. For example, each of the projecting portions 27 may be formed with two or more of the screw holes 28. Each of the screw holes 28 may be a hole with a ceiling.

As shown in FIG. 4, the outer terminal 24 of the present embodiment is formed with a center hole 29. The center hole 29 has a circular shape in a YZ-plane. The center hole 29 is located between the two projecting portions 27 in the lateral direction. The center terminal 21 is located at the center of the center hole 29 in the YZ-plane.

As shown in FIG. 9, the outer terminal 24 further has an end surface 26. The end surface 26 of the present embodiment is a plane parallel to the YZ-plane. The first receiving portion 252 is a part of the end surface 26 of the flange portion 25. Each of the projecting portions 27 projects forward in the front-rear direction from end surface 26. The contact portion 214 of the center terminal 21 is located forward of the end surface 26. The contact portion 214 extends forward in the front-rear direction beyond the end surface 26.

The end surface 26, the projecting portions 27 and the contact portion 214 of the present embodiment have the aforementioned configurations and are arranged as described above. However, the present invention is not limited thereto, but the configurations and the arrangement of the end surface 26, the projecting portions 27 and the contact portion 214 can be modified as necessary.

As shown in FIG. 5, the coaxial connector 20 of the present embodiment further comprises an insulation member 22. The coaxial connector 20 of the present embodiment comprises only the center terminal 21, the insulation member 22 and the outer terminal 24. However, the present invention is not limited thereto. For example, the coaxial connector 20 may further comprise another member in addition to the aforementioned members.

As shown in FIG. 5, the insulation member 22 encloses the body 212 of the center terminal 21 in a vertical plane, or in the YZ-plane, perpendicular to the front-rear direction. The outer terminal 24 encloses the insulation member 22 in the YZ-plane. The thus-arranged insulation member 22 is located between the center terminal 21 and the outer terminal 24 in the YZ-plane. In other words, the insulation member 22 insulates the outer terminal 24 and the center terminal 21 from each other. The center terminal 21, the insulation member 22 and the outer terminal 24 of the present embodiment are arrange as described above. However, the arrangement of the center terminal 21, the insulation member 22 and the outer terminal 24 is not specifically limited, provided that the outer terminal 24 and the center terminal 21 are insulated from each other by the insulation member 22.

As shown in FIG. 9, the fixed member 40 of the present embodiment has a flat-plate shape. As shown in FIGS. 8 and 9, the fixed member 40 has an upper surface 40U and a lower surface 40L. As shown in FIG. 7, the fixed member 40 is located below the substrate 16 in the up-down direction under the connected state where the connector assembly 12 is connected to the substrate 16. Referring to FIGS. 7 and 9, the fixed member 40 is in contact with the ground layer 78A of the substrate 16 under the connected state where the connector assembly 12 is connected to the substrate 16. As shown in FIG. 6, the fixed member 40 is in contact with the outer terminal 24 under the connected state. The fixed member 40 is made of metal. It is noted that the fixed member 40 is preferred to have a surface treatment such as, for example, gold plating in order to make reliable contact with the substrate 16 and the outer terminal 24.

As shown in FIG. 11, the fixed member 40 has a main portion 401, a first contact portion 402, two spring portions 404 and two second contact portions 405. However, the present invention is not limited thereto. Specifically, the number of the spring portion 404 may be one. In other words, the fixed member 40 should have the main portion 401, the first contact portion 402, at least one spring portion 404 and the two second contact portions 405.

As shown in FIG. 9, the main portion 401 of the present embodiment extends in the predetermined plane. In detail, the main portion 401 wholly extends in the predetermined plane. However, the present invention is not limited thereto. Specifically, a part of the main portion 401 should extend in the predetermined plane. In other words, the main portion 401 should mainly extend in the predetermined plane. As shown in FIG. 11, the main portion 401 has two extending portions 4012. The extending portions 4012 are located at opposite ends, respectively, of the main portion 401 in the lateral direction.

As shown in FIG. 11, the first contact portion 402 of the present embodiment is provided on the main portion 401. The first contact portion 402 faces rearward in the front-rear direction. The first contact portion 402 defines a rear end of the main portion 401. The first contact portion 402 is a rear end surface of the main portion 401. The first contact portion 402 is located, at least in part, between the two second contact portions 405. As shown in FIG. 6, the first contact portion 402 is in contact with the first receiving portion 252 under the connected state. In other words, the first contact portion 402 and the first receiving portion 252 are electrically connected with each other under the connected state.

As shown in FIG. 11, each of the spring portions 404 of the present embodiment extends from the main portion 401 and is resiliently deformable. Referring to FIG. 6, the two spring portions 404 correspond to the two guide portions 256, respectively, of the flange portion 25 of the coaxial connector 20. Each of the spring portions 404 has a first portion 4041 and a second portion 4042.

As shown in FIG. 11, the first portion 4041 of the present embodiment extends in the front-rear direction. Specifically, the first portion 4041 extends mainly in the front-rear direction. When the fixed member 40 is viewed alone, the first portion 4041 extends rearward in the front-rear direction and inward in the lateral direction from the main portion 401. Specifically, when the fixed member 40 is viewed alone, the first portion 4041 extends rearward in the front-rear direction and inward in the lateral direction from the extending portion 4012 of the main portion 401.

As shown in FIG. 11, the second portion 4042 of the present embodiment extends in a direction intersecting with the front-rear direction from the first portion 4041. Specifically, the second portion 4042 extends inward in the lateral direction, which is perpendicular to the front-rear direction, from the first portion 4041.

As shown in FIG. 11, the two second contact portions 405 of the present embodiment are apart from each other in the lateral direction. The two spring portions 404 support the two second contact portions 405, respectively. Accordingly, each of the two second contact portions 405 is movable in the predetermined plane. However, the present invention is not limited thereto. The fixed member 40 should be configured so that at least one of the two second contact portions 405 is supported by the spring portion 404 while the at least one second contact portion 405 is movable in the predetermined plane. The second contact portion 405 is supported by the second portion 4042. The second contact portion 405 is located in the vicinity of an inner end of the second portion 4042 in the lateral direction. Referring to FIG. 6, as described later, the guide portion 256 guides the second contact portion 405 to the second receiving portion 254 when the fixed member 40 is attached to the coaxial connector 20. Under the connected state, the second contact portion 405 is in contact with the second receiving portion 254. Under the connected state, the second contact portion 405 of the fixed member 40 made of metal is electrically connected to the second receiving portion 254 of the flange portion 25 made of metal. However, the present invention is not limited thereto. Specifically, the second contact portion 405 and the second receiving portion 254 may not be electrically connected to each other under the connected state.

As shown in FIG. 11, the fixed member 40 has a first distance D1 between the second contact portion 405 and the first contact portion 402 in the front-rear direction when the fixed member 40 is viewed alone. In other words, the fixed member 40 has the first distance D1 between the second contact portion 405 and the first contact portion 402 in the front-rear direction under an initial state where the spring portion 404 is not resiliently deformed. If the fixed member 40 has only the single spring portion 404, the fixed member 40 should have the first distance D1 between the second contact portion 405, which is supported by the spring portion 404, and the first contact portion 402 in the front-rear direction when the fixed member 40 is viewed alone. That is, if at least one of the two second contact portions 405 is supported by the spring portion 404, the fixed member 40 should have the first distance D1 between the at least one second contact portion 405 and the first contact portion 402 in the front-rear direction when the fixed member 40 is viewed alone. Referring to FIGS. 10 and 11, the first distance D1 is smaller than the second distance D2. Accordingly, under the connected state, the flange portion 25 is sandwiched between the first contact portion 402 and the second contact portion 405 of the fixed member 40 via the first receiving portion 252 and the second receiving portion 254 while the spring portion 404 is resiliently deformed.

Referring to FIG. 6, the two spring portions 404 press the two second contact portions 405 against the two second receiving portions 254, respectively, under the connected state. More specifically, under the connected state, the spring portion 404 presses the second contact portion 405 against the second receiving portion 254 while the second contact portion 405 receives reaction force from the second receiving portion 254 by the pressing of the spring portion 404. Under the connected state, the first contact portion 402 is pressed against the first receiving portion 252 along the front-rear direction by the reaction force. Accordingly, the connector assembly 12 of the present embodiment is configured so that the fixed member 40 is securely connected to the outer terminal 24 of the coaxial connector 20. Thus, the ground layer 78A of the substrate 16 is electrically connected to the first receiving portion 252 of the flange portion 25 of the outer terminal 24 via the fixed member 40 in a highly reliable manner when the connector assembly 12 of the present embodiment is connected to the substrate 16. That is, in the connector assembly 12 of the present embodiment, the outer terminal 24 can be stably connected to the ground layer 78A of the substrate 16 and this can securely reduce reflection characteristics of signals propagating between the substrate 16 and the connector assembly 12.

As shown in FIG. 8, the fixed member 40 has a pressed portion 42. As described later, the pressed portion 42 is a part which is configured to be pressed against the substrate 16 under the connected state. According to the present embodiment, a middle part of the upper surface 40U in the lateral direction mainly works as the pressed portion 42.

As shown in FIG. 9, the fixed member 40 of the present embodiment is formed with two fixing holes 45. Each of the fixing holes 45 passes through the fixed member 40 in the up-down direction. As shown in FIG. 11, each of the fixing holes 45 has a circular shape in the horizontal plane. Referring to FIG. 8, the fixing holes 45 are provided at positions which correspond to those of the passing holes 72, respectively, of the substrate 16 in the horizontal plane. The thus-arranged two fixing holes 45 are apart from each other in the lateral direction and are located at positions same as each other in the front-rear direction.

The fixed member 40 of the present embodiment has the aforementioned configuration. However, the present invention is not limited thereto. For example, the shape of each of the fixing holes 45 is not specifically limited. Moreover, the number of the fixing holes 45 may be three or more.

Referring to FIG. 7, the connector assembly 12 forms the structure 10 together with the substrate 16 connected thereto. The substrate 16 of the structure 10 is located between the fixed member 40 and each of the projecting portions 27 of the outer terminal 24 in the up-down direction. Referring to FIGS. 3 and 5, the signal line 74 of the substrate 16 is pressed by the fixed member 40 from below, and thereby the signal line 74 is pressed against and in contact with the contact portion 214 of the center terminal 21. Accordingly, the contact portion 214 and the signal line 74 are electrically connected to each other. However, the present invention is not limited thereto. Specifically, the contact portion 214 and the signal line 74 may be connected to each other by soldering.

As shown in FIG. 9, the two fixing members 60 of the present embodiment have shapes same as each other. More specifically, each of the fixing members 60 of the present embodiment is a screw 60. Accordingly, each of the fixing members 60 is formed with a thread (not shown). More in detail, each of the fixing members 60 is a right-hand screw 60 made of metal. The fixing members 60 are provided so that they correspond to the passing holes 72, respectively, of the substrate 16. Accordingly, the number of the fixing members 60 of the present embodiment is two. However, the present invention is not limited thereto. For example, the connector assembly 12 may be provided with three or more of the fixing members 60 which have shapes different from each other. Referring to FIGS. 2 and 9, each of the fixing members 60 is screwed into the screw hole 28 through the fixing hole 45 of the fixed member 40 and the passing hole 72 of the substrate 16 under the connected state.

The connector assembly 12 of the present embodiment is configured to be connected to the substrate 16 by a connection method described below. The connection method described below is merely an example and can be modified as necessary.

Referring to FIGS. 8 and 9, the coaxial connector 20 and the substrate 16 are firstly arranged in the up-down direction so that the lower surface 27L of the projecting portion 27 of the coaxial connector 20 and the upper surface 70U of the substrate 16 are in contact with each other in the up-down direction while the screw hole 28 of the coaxial connector 20 and the passing hole 72 of the substrate 16 are located at positions same as each other in the horizontal plane.

Next, the fixed member 40 is arranged relative to the coaxial connector 20 and the substrate 16 in the up-down direction so that the lower surface 70L of the substrate 16 faces the upper surface 40U of the fixed member 40 in the up-down direction while each of the guide portions 256 of the coaxial connector 20 and the second contact portion 405 of the corresponding spring portion 404 of the fixed member 40 are located at positions same as each other in the horizontal plane.

After that, the fixed member 40 is moved so that it approaches the coaxial connector 20 and the substrate 16 in the up-down direction. Then, the second contact portion 405 of the fixed member 40 is brought into contact with the guide portion 256 of the coaxial connector 20.

From this state, the fixed member 40 is further moved so that it approaches the coaxial connector 20 and the substrate 16 in the up-down direction. Then, the second contact portion 405 of the fixed member 40 rides over the guide portion 256 of the coaxial connector 20 and rides on the corresponding second receiving portion 254 of the coaxial connector 20, while the upper surface 40U of the fixed member 40 is brought into contact with the lower surface 70L of the substrate 16 in the up-down direction.

In this state, the first contact portion 402 of the fixed member 40 is in contact with the first receiving portion 252 of the coaxial connector 20 in the front-rear direction while the second contact portion 405 of the fixed member 40 is in contact with the corresponding second receiving portion 254 of the coaxial connector 20 in the front-rear direction. Additionally, in this state, each of the spring portions 404 presses the corresponding second contact portion 405 against the corresponding second receiving portion 254 while the second contact portion 405 receives the reaction force from the second receiving portion 254 by the pressing of the spring portion 404. Furthermore, in this state, the first contact portion 402 is pressed against the first receiving portion 252 along the front-rear direction by the reaction force.

After that, each of the fixing members 60 is screwed into the screw hole 28 of the projecting portion 27 of the coaxial connector 20 through the fixing hole 45 of the fixed member 40 and the passing hole 72 of the substrate 16. Accordingly, the connector assembly 12 changes its state into the connected state where the connector assembly 12 is connected to the substrate 16.

Referring to FIGS. 3 and 5, the contact portion 214 of the center terminal 21 is brought into contact with the signal line 74 of the substrate 16 under the connected state. As described above, under the pre-connected state, the contact portion 214 of the center terminal 21 extends forward and downward while the lower end of the contact portion 214 is located downward of the lower surface 27L of the projecting portion 27. Accordingly, under the connected state, the contact portion 214 is brought into abutment with the signal line 74 of the substrate 16 and is resiliently deformed. This resilient deformation generates restoring force which presses the contact portion 214 against the signal line 74 from above.

As shown in FIG. 5, the fixed member 40 is located below the substrate 16 in the up-down direction under the connected state. Referring to FIGS. 5 and 9, under the connected state, a head of each of the fixing members 60 is pressed against the lower surface 40L of the fixed member 40 and presses the fixed member 40 upward. The upper surface 40U of the thus-pressed fixed member 40 presses the substrate 16 against the lower surfaces 27L of the projecting portions 27. As a result, the substrate 16 is sandwiched and held between the fixed member 40 and each of the projecting portions 27. The thus-sandwiched substrate 16 has a contact region which is located below the contact portion 214 of the center terminal 21. The pressed portion 42 (see FIG. 8) of the fixed member 40 is pressed against the contact region of the substrate 16 and supports the contact region from below. If the substrate 16 is a flexible board, the contact region of the substrate 16 is not bent even when force is applied thereto from above. Under the connected state, the fixed member 40 is pressed against the ground layer 78A of the substrate 16 so that the predetermined plane becomes perpendicular to the up-down direction.

That is, under the connected state, the two fixing members 60 are fixed to the two projecting portions 27 of the outer terminal 24 through the two passing holes 72, respectively, of the substrate 16 while the two fixing members 60 press the fixed member 40 against the ground layer 78A of the substrate 16 so that the predetermined plane becomes perpendicular to the up-down direction.

Referring to FIGS. 4 and 9, the outer terminal 24 is grounded to the ground layer 78A of the lower surface 70L of the substrate 16 via the projecting portions 27, the fixing members 60 and the fixed member 40 under the connected state.

The structure 10 of the present embodiment can be further variously modified in addition to the already explained various modifications. Hereafter, explanation will be made about fifth modifications of the structure 10, focusing on differences from the structure 10.

### (First Modification)

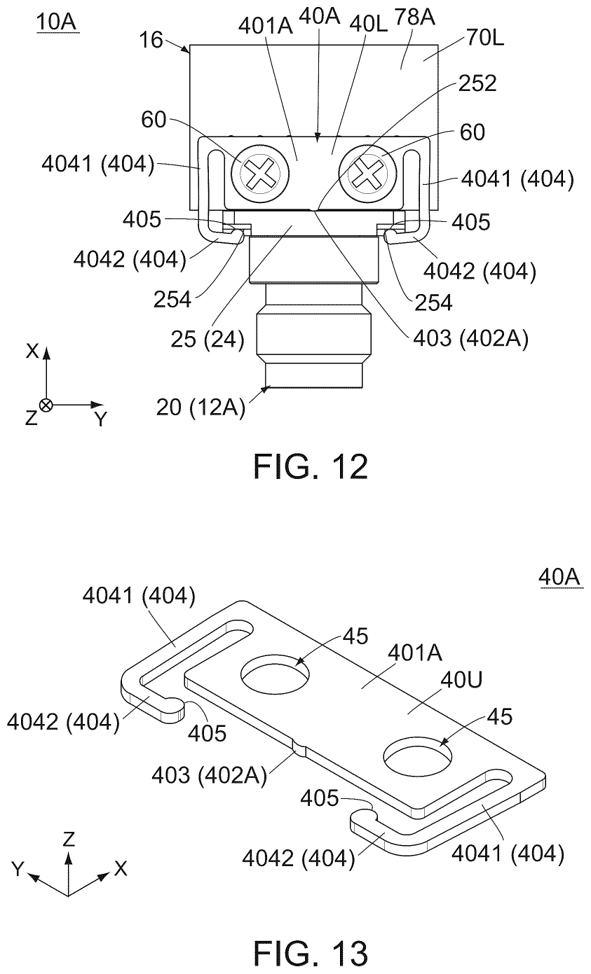

Comparing FIG. 12 with FIG. 6, a structure 10A according to a first modification comprises a connector assembly 12A and a substrate 16. The substrate 16 of the present modification has a configuration same as that of the substrate 16 of the aforementioned embodiment. Accordingly, a detailed description thereabout is omitted. The connector assembly 12A is configured to be connected to the substrate 16 similarly to the connector assembly 12.

As shown in FIG. 12, the connector assembly 12A of the present modification comprises a coaxial connector 20, a fixed member 40A and two fixing members 60. The coaxial connector 20 and the fixing member 60 of the present modification have configurations same as those of the coaxial connector 20 and the fixing member 60 of the aforementioned embodiment. Accordingly, a detailed description thereabout is omitted.

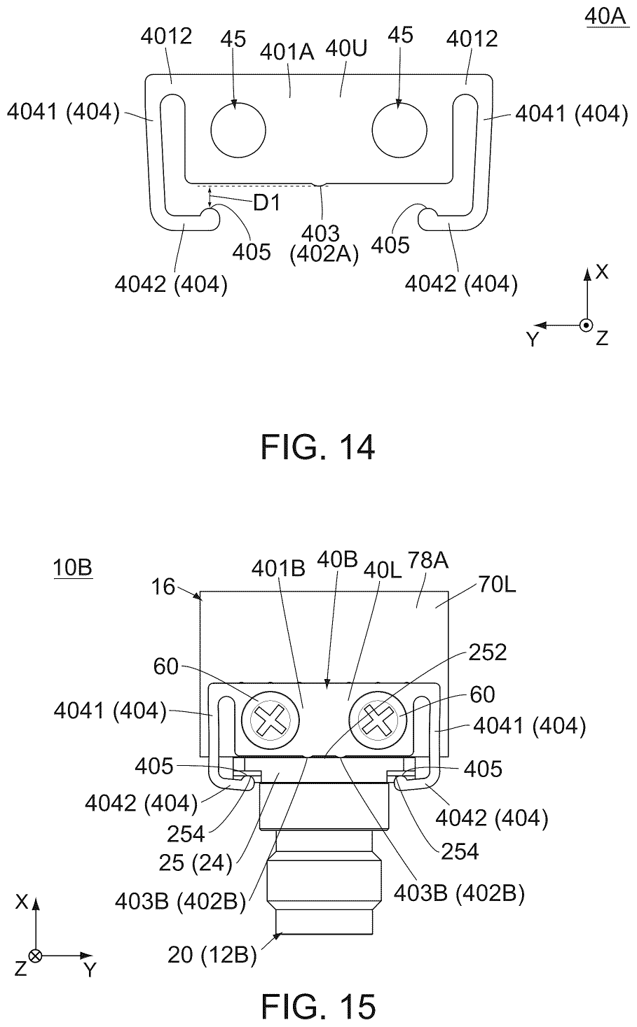

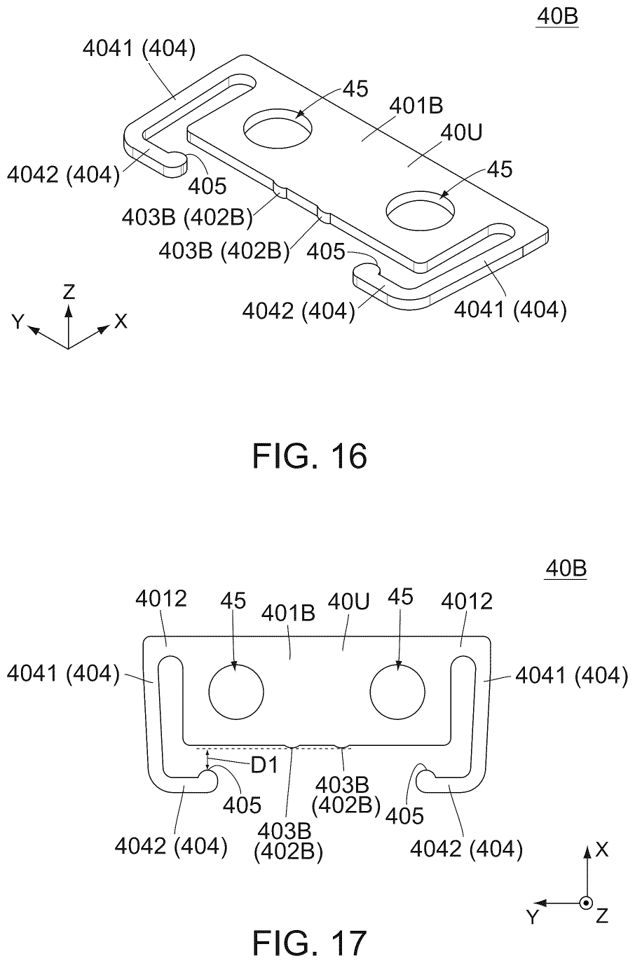

As shown in FIG. 14, the fixed member 40A of the present modification has a main portion 401A, a first contact portion 402A, two spring portions 404 and two second contact portions 405. The spring portion 404 and the second contact portion 405 of the present modification have configurations same as those of the spring portion 404 and the second contact portion 405 of the aforementioned embodiment. Accordingly, a detailed description thereabout is omitted.

As shown in FIG. 14, the main portion 401A of the present modification extends in the predetermined plane. In detail, the main portion 401A wholly extends in the predetermined plane. The main portion 401A has two extending portions 4012. The extending portion 4012 of the preset modification has a configuration same as that of the extending portion 4012 of the aforementioned embodiment. Accordingly, a detailed description thereabout is omitted.

As shown in FIG. 14, the first contact portion 402A of the present modification consists of a protrusion 403. The protrusion 403 is located at a middle of the fixed member 40A in the lateral direction. The protrusion 403 protrudes rearward in the front-rear direction from the main portion 401A. As shown in FIG. 12, the protrusion 403 is in contact with a first receiving portion 252 under a connected state where the connector assembly 12A is connected to the substrate 16. In other words, the protrusion 403 of the fixed member 40A and the first receiving portion 252 of a flange portion 25 are electrically connected to each other under the connected state. Referring to FIGS. 12 and 3, the protrusion 403 is located between two projecting portions 27 in the lateral direction under the connected state. The protrusion 403 is located at a position same as that of a contact portion 214 of a center terminal 21 in the lateral direction under the connected state. The protrusion 403 is located in the vicinity of the contact portion 214 of the center terminal 21 under the connected state.

As shown in FIG. 14, the fixed member 40A has a first distance D1 between the second contact portion 405 and the first contact portion 402A in the front-rear direction when the fixed member 40A is viewed alone. In other words, the fixed member 40A has the first distance D1 between the second contact portion 405 and the first contact portion 402A in the front-rear direction under an initial state where the spring portion 404 is not resiliently deformed. Referring to FIGS. 10 and 14, the first distance D1 is smaller than a second distance D2. Accordingly, under the connected state, the flange portion 25 is sandwiched between the first contact portion 402A and the second contact portion 405 of the fixed member 40A via the first receiving portion 252 and a second receiving portion 254 while the spring portion 404 is resiliently deformed.

Referring to FIG. 12, the two spring portions 404 press the two second contact portions 405 against two second receiving portions 254, respectively, under the connected state. More specifically, under the connected state, the spring portion 404 presses the second contact portion 405 against the second receiving portion 254 while the second contact portion 405 receives reaction force from the second receiving portion 254 by the pressing of the spring portion 404. Under the connected state, the first contact portion 402A is pressed against the first receiving portion 252 along the front-rear direction by the reaction force. Accordingly, the connector assembly 12A of the present modification is also configured so that the fixed member 40A is securely connected to an outer terminal 24 of the coaxial connector 20. Thus, a ground layer 78A of the substrate 16 is electrically connected to the first receiving portion 252 of the flange portion 25 of the outer terminal 24 via the fixed member 40A in a highly reliable manner when the connector assembly 12A of the present modification is connected to the substrate 16. That is, in the connector assembly 12A of the present modification, the outer terminal 24 of the coaxial connector 20 of the connector assembly 12A can be stably connected to the ground layer 78A of the substrate 16 and this can securely reduce reflection characteristics of signals propagating between the substrate 16 and the connector assembly 12A.

As described above, the first contact portion 402A, which is located in the vicinity of the contact portion 214 of the center terminal 21 of the coaxial connector 20, is pressed against the first receiving portion 252 along the front-rear direction under the connected state. This enables the fixed member 40A to be always in contact with the flange portion 25 at the vicinity of the contact portion 214 of the center terminal 21 of the coaxial connector 20 under the connected state.

It has been found that, in order to reduce reflection characteristics of signals propagating between the substrate 16 and the connector assembly 12, 12A, it is preferable that the fixed member 40A, 40 is in contact with the flange portion 25 at the vicinity of the center terminal 21 of the coaxial connector 20 under the connected state.

As described above, the connector assembly 12A of the present modification is configured so that the fixed member 40A is always in contact with the flange portion 25 at the vicinity of the contact portion 214 of the center terminal 21 of the coaxial connector 20 under the connected state. Accordingly, the connector assembly 12A of the present modification can securely reduce reflection characteristics of signals, which propagate between the substrate 16 and the connector assembly 12A, under connected state even if, for example, contact force between the first contact portion 402A and the first receiving portion 252 is not large.

### (Second Modification)

Comparing FIG. 15 with FIG. 6, a structure 10B according to a second modification comprises a connector assembly 12B and a substrate 16. The substrate 16 of the present modification has a configuration same as that of the substrate 16 of the aforementioned embodiment. Accordingly, a detailed description thereabout is omitted. The connector assembly 12B is configured to be connected to the substrate 16 similarly to the connector assembly 12.

As shown in FIG. 15, the connector assembly 12B of the present modification comprises a coaxial connector 20, a fixed member 40B and two fixing members 60. The coaxial connector 20 and the fixing member 60 of the present modification have configurations same as those of the coaxial connector 20 and the fixing member 60 of the aforementioned embodiment. Accordingly, a detailed description thereabout is omitted.

As shown in FIG. 17, the fixed member 40B of the present modification has a main portion 401B, a first contact portion 402B, two spring portions 404 and two second contact portions 405. The spring portion 404 and the second contact portion 405 of the present modification have configurations same as those of the spring portion 404 and the second contact portion 405 of the aforementioned embodiment. Accordingly, a detailed description thereabout is omitted.

As shown in FIG. 17, the main portion 401B of the present modification extends in a predetermined plane. In detail, the main portion 401B wholly extends in the predetermined plane. The main portion 401B has two extending portions 4012. The extending portion 4012 of the present modification has a configuration same as that of the extending portion 4012 of the aforementioned embodiment. Accordingly, a detailed description thereabout is omitted.

As shown in FIG. 17, the first contact portion 402B of the second modification consists of two protrusions 403B. However, the present invention is not limited thereto. Specifically, the first contact portion 402B may comprise at least one protrusion 403B. Each of the protrusions 403B is positioned around a middle of the fixed member 40B in the lateral direction. Each of the protrusions 403B protrudes rearward in the front-rear direction from the main portion 401B. As shown in FIG. 15, under a connected state where the connector assembly 12B is connected to the substrate 16, each of the protrusions 403B is in contact with a first receiving portion 252. In other words, each of the protrusions 403B of the fixed member 40B is electrically connected to the first receiving portion 252 of a flange portion 25 under the connected state. Referring to FIGS. 15 and 3, each of the protrusions 403B is located between two projecting portions 27 in the lateral direction under the connected state. The two protrusions 403B are located at opposite sides, respectively, of a contact portion 214 of a center terminal 21 in the lateral direction under the connected state. Each of the protrusions 403B is located in the vicinity of the contact portion 214 of the center terminal 21 under the connected state.

As shown in FIG. 17, the fixed member 40B has a first distance D1 between the second contact portion 405 and the first contact portion 402B in the front-rear direction when the fixed member 40B is viewed alone. In other words, the fixed member 40B has the first distance D1 between the second contact portion 405 and the first contact portion 402B in the front-rear direction under an initial state where the spring portion 404 is not resiliently deformed. Referring to FIGS. 10 and 17, the first distance D1 is smaller than a second distance D2. Accordingly, under the connected state, the flange portion 25 is sandwiched between the first contact portion 402B and the second contact portion 405 of the fixed member 40B via the first receiving portion 252 and a second receiving portion 254 while the spring portion 404 is resiliently deformed.

Referring to FIG. 15, the two spring portions 404 press the two second contact portions 405 against two second receiving portions 254, respectively, under the connected state. More specifically, under the connected state, the spring portion 404 presses the second contact portion 405 against the second receiving portion 254 while the second contact portion 405 receives reaction force from the second receiving portion 254 by the pressing of the spring portion 404. Under the connected state, the first contact portion 402B is pressed against the first receiving portion 252 along the front-rear direction by the reaction force. Accordingly, the connector assembly 12B of the present modification is configured so that the fixed member 40B is securely connected to an outer terminal 24 of the coaxial connector 20. Thus, the ground layer 78A of the substrate 16 is electrically connected to the first receiving portion 252 of the flange portion 25 of the outer terminal 24 via the fixed member 40B in a highly reliable manner when the connector assembly 12B of the present modification is connected to the substrate 16. That is, in the connector assembly 12B of the present modification, the outer terminal 24 of the coaxial connector 20 of the connector assembly 12B can be stably connected to the ground layer 78A of the substrate 16 and this can securely reduce reflection characteristics of signals propagating between the substrate 16 and the connector assembly 12B.

As described above, the first contact portion 402B, which is located in the vicinity of the contact portion 214 of the center terminal 21 of the coaxial connector 20, is pressed against the first receiving portion 252 along the front-rear direction under the connected state. This enables the fixed member 40B to be always in contact with the flange portion 25 at the vicinity of the contact portion 214 of the center terminal 21 of the coaxial connector 20 under the connected state. Accordingly, similar to the first modification, the connector assembly 12B of the present modification can securely reduce reflection characteristics of signals, which propagate between the substrate 16 and the connector assembly 12B, under connected state even if, for example, contact force between the first contact portion 402B and the first receiving portion 252 is not large.

### (Third Modification)

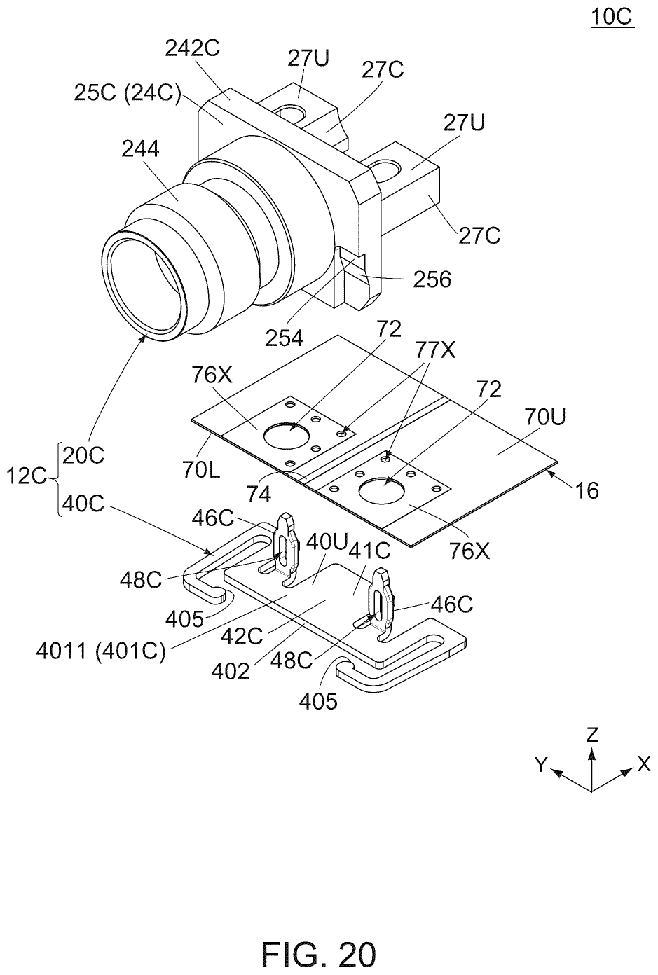

Comparing FIG. 20 with FIG. 8, a structure 10C according to a third modification comprises a connector assembly 12C and a substrate 16. The substrate 16 of the present modification has a configuration same as that of the substrate 16 of the aforementioned embodiment. Accordingly, a detailed description thereabout is omitted. The connector assembly 12C is configured to be connected to the substrate 16 similarly to the connector assembly 12.

Comparing FIG. 20 with FIG. 8, the connector assembly 12C of the present modification comprises a coaxial connector 20C and a connection member 40C. The connection member 40C is a single metal plate with bends. The connection member 40C according to the present modification has a predetermined portion which works as a fixed member 41C and two portions other than the predetermined portion which work as fixing members 46C. The thus-formed connector assembly 12C comprises the coaxial connector 20C different from the coaxial connector 20, the fixed member 41C different from the fixed member 40 and the two fixing members 46C different from the fixing members 60. Each of the fixed member 41C and the fixing member 46C of the present modification is a part of the connection member 40C. In other words, the fixed member 41C and the two fixing members 46C are integrally formed with each other.

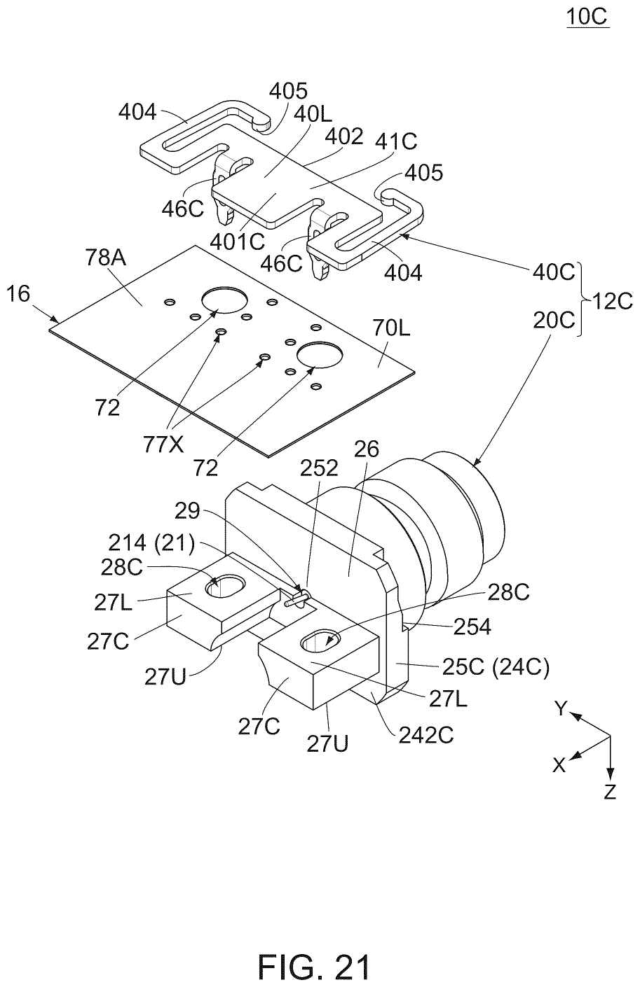

As shown in FIG. 21, the coaxial connector 20C comprises an outer terminal 24C different from the outer terminal 24. The coaxial connector 20C has a configuration same as that of the coaxial connector 20 except for the outer terminal 24C. The outer terminal 24C has a front conductive member 242C different from the front conductive member 242. The outer terminal 24C has a configuration same as that of the outer terminal 24 except for the front conductive member 242C. The front conductive member 242C has projecting portions 27C different from the projecting portions 27. The front conductive member 242C has a configuration same as that of the front conductive member 242 except for the projecting portions 27C.

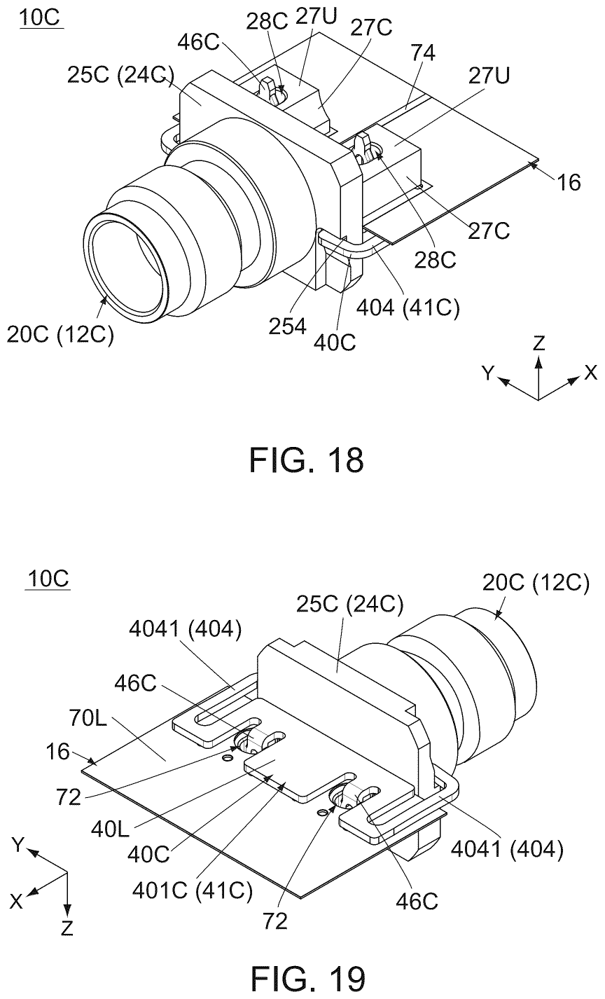

Referring to FIG. 18 together with FIG. 5, the coaxial connector 20C is configured to be attached to a front end of a coaxial cable 80. Referring to FIG. 21, the coaxial connector 20C comprises the outer terminal 24C, a center terminal 21 and an insulation member (not shown). The insulation member insulates the outer terminal 24C and the center terminal 21 from each other. The outer terminal 24C has an end surface 26 and the two projecting portions 27C. The two projecting portions 27C are apart from each other in the lateral direction and project forward from the end surface 26.

As shown in FIG. 21, Each of the projecting portions 27C is formed with a press-fit hole 28C. The coaxial connector 20C is formed with the press-fit holes 28C instead of the screw holes 28. The coaxial connector 20C has a configuration same as that of the coaxial connector 20 except for this difference. Each of the press-fit holes 28C of the present modification passes through the projecting portion 27C in the up-down direction. However, the present invention is not limited thereto. Specifically, each of the press-fit holes 28C may be a hole with a ceiling. Each of the press-fit holes 28C is an elongated hole extending in the front-rear direction. The press-fit holes 28C are provided at positions which correspond to those of the passing holes 72, respectively, of the substrate 16 in the horizontal plane. The thus-arranged two press-fit holes 28C are apart from each other in the lateral direction and are located at positions same as each other in the front-rear direction. The number of the press-fit holes 28C of the present modification is two. However, the present invention is not limited thereto. For example, each of the projecting portions 27C may be formed with two or more of the press-fit holes 28C.

As shown in FIG. 21, the center terminal 21 has a contact portion 214. The contact portion 214 is located between the two projecting portions 27C in the lateral direction and extends forward beyond the end surface 26. In detail, the contact portion 214 extends forward and downward under a pre-connected state where the connector assembly 12C is not yet connected to the substrate 16.

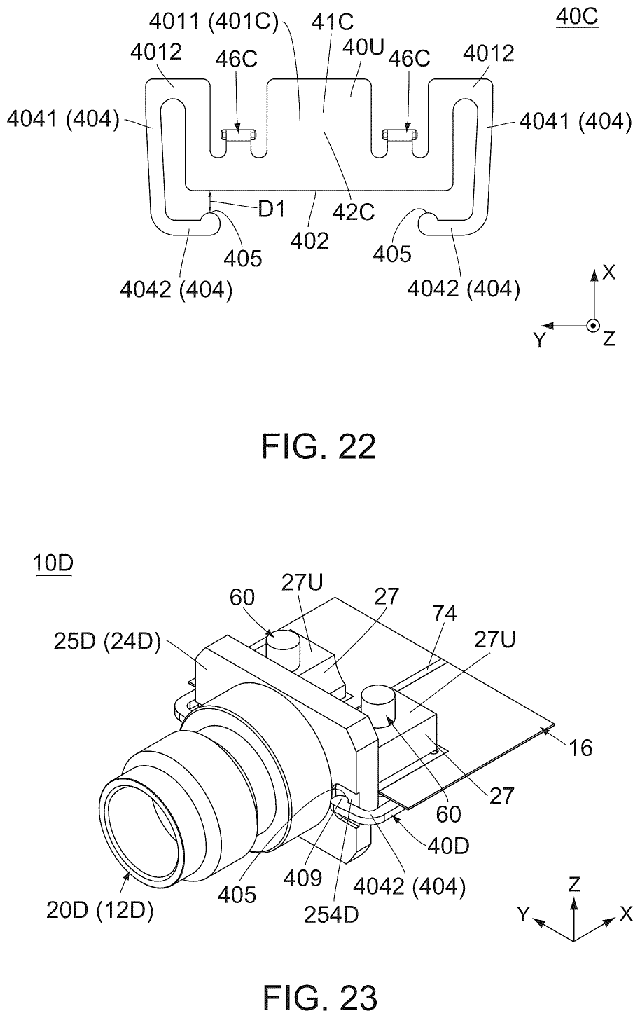

As shown in FIG. 22, the connection member 40C has a fixed member 41C, a pressed portion 42C and two press-fit portions 46C or two fixing members 46C. According to the present modification, each of the press-fit portions 46C works as the fixing member 46C. In other words, each of the fixing members 46C of the present modification is the press-fit portion 46C.

As shown in FIG. 22, the fixed member 41C has a main portion 401C, a first contact portion 402, two spring portions 404 and two second contact portions 405. However, the present invention is not limited thereto. Specifically, the number of the spring portion 404 may be one. In other words, the fixed member 41C should have the main portion 401C, the first contact portion 402, at least one spring portion 404 and the two second contact portions 405. The first contact portion 402, the spring portion 404 and the second contact portion 405 of the present modification have configurations same as those of the first contact portion 402, the spring portion 404 and the second contact portion 405 of the aforementioned embodiment. Accordingly, a detailed description thereabout is omitted.

As shown in FIG. 22, the main portion 401C of the present modification extends in a predetermined plane. In detail, the main portion 401C wholly extends in the predetermined plane. However, the present invention is not limited thereto. Specifically, a part of the main portion 401C should extend in the predetermined plane. In other words, the main portion 401C should mainly extend in the predetermined plane.

As shown in FIG. 22, the main portion 401C has a coupling portion 4011 and two extending portions 4012. The extending portion 4012 of the present modification has a configuration same as that of the extending portion 4012 of the aforementioned embodiment. Accordingly, a detailed description thereabout is omitted.

Referring to FIGS. 20 and 21, the coupling portion 4011 has an upper surface 40U and a lower surface 40L. According to the present modification, a middle part of the upper surface 40U of the coupling portion 4011 in the lateral direction mainly works as the pressed portion 42C. As shown in FIG. 22, the two press-fit portions 46C are located at opposite sides, respectively, of the coupling portion 4011 in the lateral direction. The coupling portion 4011 couples the two press-fit portions 46C together in the lateral direction. In detail, each of the press-fit portions 46C is connected to the coupling portion 4011. As shown in FIG. 20, each of the press-fit portions 46C extends upward beyond the coupling portion 4011.

Referring to FIGS. 19 and 21, the first contact portion 402 of the fixed member 41C is in contact with the first receiving portion 252 of the flange portion 25C under a connected state where the connector assembly 12C is connected to the substrate 16. In other words, the first contact portion 402 of the fixed member 41C and the first receiving portion 252 of the flange portion 25C are electrically connected to each other under the connected state. Referring to FIGS. 18 and 20, the second contact portion 405 of the fixed member 41C is in contact with the second receiving portion 254 of the flange portion 25C under the connected state. In other words, the second contact portion 405 of the fixed member 41C and the second receiving portion 254 of the flange portion 25C are electrically connected to each other under the connected state.

As shown in FIG. 22, the fixed member 41C has a first distance D1 between the second contact portion 405 and the first contact portion 402 in the front-rear direction when the fixed member 41C is viewed alone. In other words, the fixed member 41C has the first distance D1 between the second contact portion 405 and the first contact portion 402 in the front-rear direction under an initial state where the spring portion 404 is not resiliently deformed. Referring to FIGS. 10 and 22, the first distance D1 is smaller than a second distance D2. Accordingly, under the connected state, the flange portion 25C is sandwiched between the first contact portion 402 and the second contact portion 405 of the fixed member 41C via the first receiving portion 252 and the second receiving portion 254 while the spring portion 404 is resiliently deformed.

Referring to FIGS. 18, 19 and 20, the two spring portions 404 press the two second contact portions 405 against the two second receiving portions 254, respectively, under the connected state. More specifically, under the connected state, the spring portion 404 presses the second contact portion 405 against the second receiving portion 254 while the second contact portion 405 receives reaction force from the second receiving portion 254 by the pressing of the spring portion 404. Referring to FIGS. 19 and 21, the first contact portion 402 is pressed against the first receiving portion 252 along the front-rear direction by the reaction force under the connected state. Accordingly, the connector assembly 12C of the present modification is configured so that the fixed member 41C is securely connected to the outer terminal 24C of the coaxial connector 20C. Thus, the ground layer 78A of the substrate 16 is electrically connected to the first receiving portion 252 of the flange portion 25C of the outer terminal 24C via the fixed member 41C in a highly reliable manner when the connector assembly 12C of the present modification is connected to the substrate 16. That is, in the connector assembly 12C of the present modification, the outer terminal 24C can be stably connected to the ground layer 78A of the substrate 16 and this can securely reduce reflection characteristics of signals propagating between the substrate 16 and the connector assembly 12C.

Referring to FIGS. 18 and 20, a size of each of the press-fit holes 28C in the lateral direction is smaller than a size of each of the press-fit portions 46C in the lateral direction. Each of the press-fit portions 46C is inserted into the press-fit hole 28C through the passing hole 72 of the substrate 16 under the connected state. As shown in FIG. 20, each of the press-fit portions 46C is formed with a hole portion 48C. Each of the hole portions 48C extends in the up-down direction and passes through the press-fit portion 46C in the front-rear direction. Each of the press-fit portions 46C, which is formed with the hole portion 48C, is resiliently deformed so as to be partially compressed in the lateral direction when each of the press-fit portions 46C receives force along the lateral direction. Each of the press-fit portions 46C, which is resiliently deformed, generates force directed outward in the lateral direction because of its restoring force.

As described above, each of the press-fit holes 28C is the elongated hole extending in the front-rear direction. Accordingly, the connector assembly 12C provides some flexibility in positions of the press-fit portions 46C in the front-rear direction relative to the press-fit holes 28C when the press-fit portions 46C are press-fit into the press-fit holes 28C, respectively. Accordingly, the press-fit portions 46C can be appropriately press-fit into the press-fit holes 28C so that the first contact portion 402 of the fixed member 41C is securely in contact with the first receiving portion 252 of the flange portion 25 without any gap therebetween in the front-rear direction.

Comparing FIG. 18 with FIG. 1, the connector assembly 12C is configured to be connected to the substrate 16 not by the connection method of the connector assembly 12 in which the screws 60 are screwed but by another connection method in which the press-fit portions 46C are press-fit.

In detail, when the connector assembly 12C is connected to the substrate 16, each of the press-fit portions 46C is inserted into the press-fit hole 28C of the coaxial connector 20C through the passing hole 72 of the substrate 16. As described above, the size of each of the press-fit holes 28C in the lateral direction is smaller than the size of each of the press-fit portions 46C in the lateral direction. Accordingly, each of the press-fit portions 46C is inserted into the press-fit hole 28C while being compressed in the lateral direction. The press-fit portion 46C inserted into each of the press-fit holes 28C is pressed against an inner wall surface of the press-fit hole 28C by its restoring force. As a result, the connection member 40C is fixed to the coaxial connector 20C, and the connector assembly 12C is connected to the substrate 16.

Referring FIG. 19, the fixed member 41C of the connection member 40C is located below the substrate 16 in the up-down direction under the connected state where the connector assembly 12C is connected to the substrate 16. Referring to FIGS. 18 and 20, under the connected state, the two fixing members 46C of the connection member 40C are fixed to the two projecting portions 27C of the outer terminal 24C through the two passing holes 72, respectively, of the substrate 16 while the two fixing members 46C press the pressed portion 42C of the fixed member 41C against a part of the lower surface 70L of the substrate 16 just above which the signal line 74 is formed. Accordingly, the contact portion 214 (see FIG. 21) of the center terminal 21 is pressed against and is brought into contact with the signal line 74 of the substrate 16, and thereby the contact portion 214 and the signal line 74 are electrically connected to each other. However, the present invention is not limited thereto. Specifically, the contact portion 214 and the signal line 74 may be connected to each other by soldering.

According to the present modification, each of the press-fit portions 46C is press-fit into the press-fit hole 28C through the passing hole 72 of the substrate 16 under the connected state. The connection method using the press-fitting can be easily performed in a short time in comparison with the connection method using the screwing.

### (Fourth Modification)

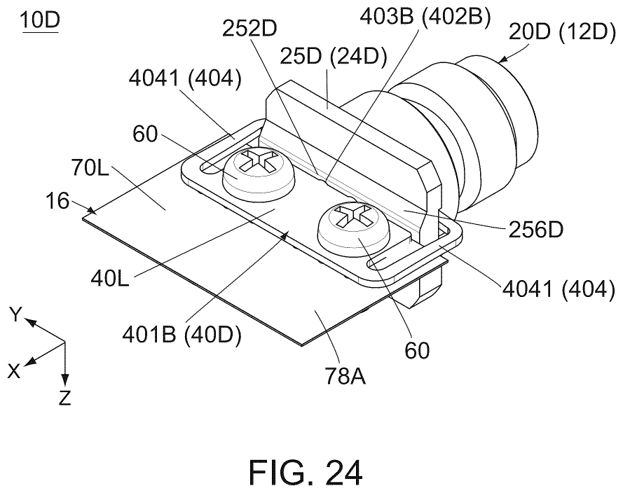

Comparing FIG. 24 with FIG. 2, a structure 10D according to a fourth modification comprises a connector assembly 12D and a substrate 16. The substrate 16 of the present modification has a configuration same as that of the substrate 16 of the aforementioned embodiment. Accordingly, a detailed description thereabout is omitted. The connector assembly 12D is configured to be connected to the substrate 16 similarly to the connector assembly 12.

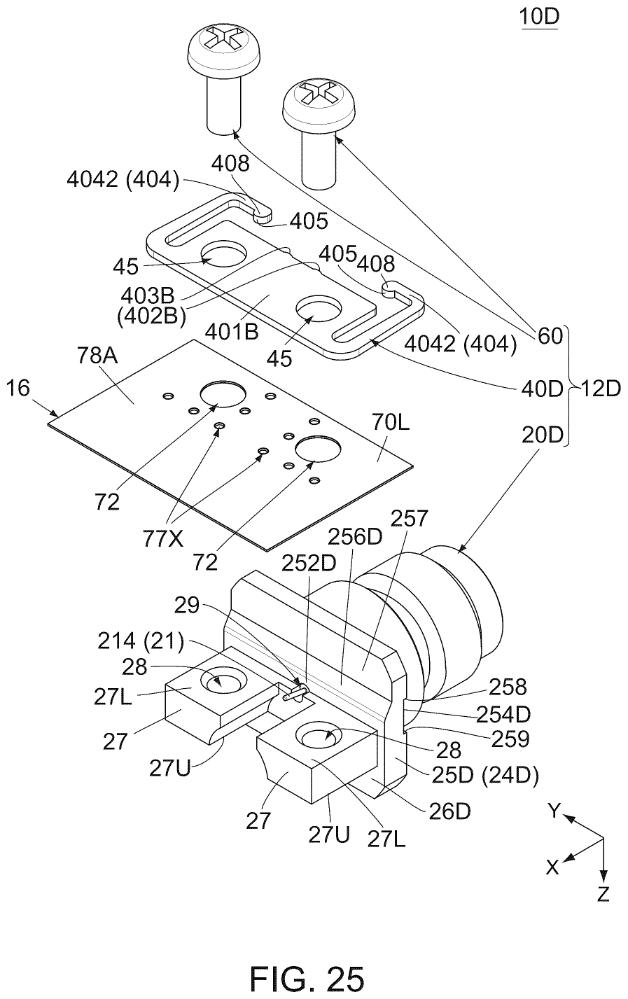

As shown in FIG. 25, the connector assembly 12D of the present modification comprises a coaxial connector 20D, a fixed member 40D and two fixing members 60. The fixing member 60 of the present modification has a configuration same as that of the fixing member 60 of the aforementioned embodiment. Accordingly, a detailed description thereabout is omitted.

Referring to FIG. 25, the coaxial connector 20D of the present modification comprises a center terminal 21 made of conductor, an insulation member (not shown) made of insulator and an outer terminal 24D made of conductor. The center terminal 21 and the insulation member have configurations same as those of the center terminal 21 and the insulation member 22 of the aforementioned embodiment. Accordingly, a detailed description thereabout is omitted.

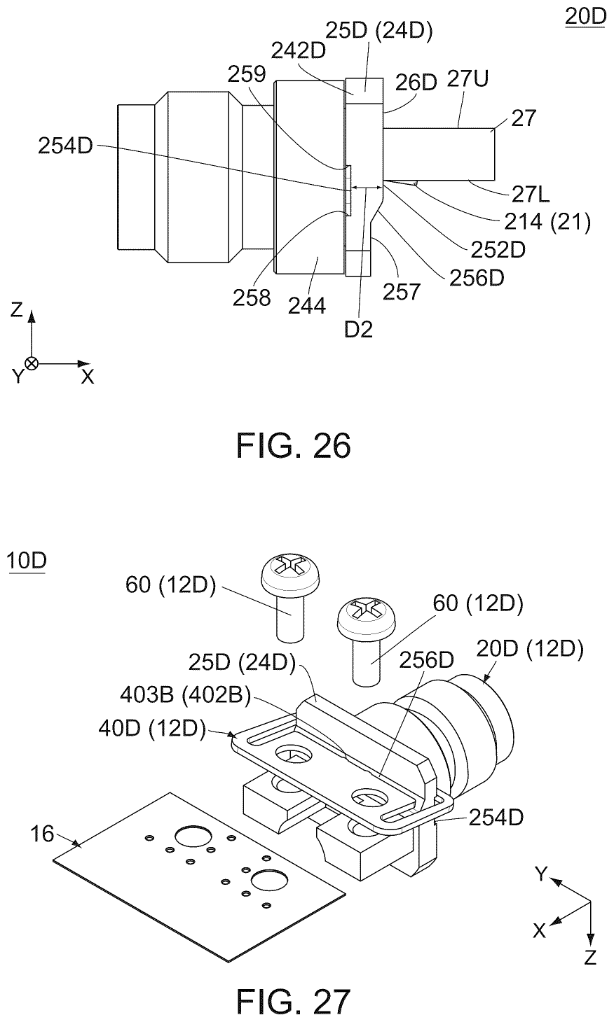

As shown in FIG. 26, the outer terminal 24D of the present modification comprises a front conductive member 242D and a rear conductive member 244. The rear conductive member 244 of the present modification has a configuration same as that of the rear conductive member 244 of the aforementioned embodiment. Accordingly, a detailed description thereabout is omitted.

As shown in FIG. 25, the outer terminal 24D of the present modification has a flange portion 25D and two projecting portions 27. The projecting portion 27 of the present modification has a configuration same as that of the projecting portion 27 of the aforementioned embodiment. Accordingly, a detailed description thereabout is omitted.

Referring to FIG. 26, the flange portion 25D of the present modification has a first receiving portion 252D and two second receiving portions 254D.

As shown in FIG. 25, the first receiving portion 252D faces forward in the front-rear direction perpendicular to both the up-down direction and the lateral direction. The first receiving portion 252D is located around a middle of the flange portion 25D in the up-down direction. The first receiving portion 252D is located at a middle of the flange portion 25D in the lateral direction.

Referring to FIG. 26, each of the two second receiving portions 254D faces rearward in the front-rear direction. However, the present invention is not limited thereto. The second receiving portion 254D may face rearward in the front-rear direction and outward in the lateral direction. In other words, each of the two second receiving portions 254D should face at least rearward in the front-rear direction. The second receiving portions 254D are located at opposite ends, respectively, of the flange portion 25D in the lateral direction.

As shown in FIG. 26, the first receiving portion 252D is located forward of any of the second receiving portions 254D in the front-rear direction. However, the present invention is not limited thereto. The first receiving portion 252D may be located rearward of the second receiving portion 254D in the front-rear direction, provided that the first receiving portion 252D faces forward while the second receiving portion 254D faces at least rearward. If the first receiving portion 252D and the second receiving portions 254D are configured similar to the present modification, the flange portion 25D can have a reduced size in the front-rear direction. Accordingly, the first receiving portion 252D and the second receiving portions 254D of the present modification are more preferable. The flange portion 25D has a second distance D2 between the first receiving portion 252D and any of the second receiving portions 254D in the front-rear direction.

Referring to FIG. 26, the flange portion 25D of the present modification has a plane portion 257, an end surface 26D, a guide portion 256D, two first stopping portions 258 and two second stopping portions 259.

As shown in FIG. 26, the plane portion 257 of the present modification is a plane parallel to a YZ-plane. The plane portion 257 defines a lower end of the flange portion 25D in the up-down direction.

As shown in FIG. 26, the end surface 26D of the present modification is a plane parallel to the YZ-plane. The first receiving portion 252D is a part of the end surface 26D of the flange portion 25D. Each of the two projecting portions 27 projects forward in the front-rear direction from the end surface 26D. A contact portion 214 of the center terminal 21 is located forward of the end surface 26D in the front-rear direction. The contact portion 214 extends forward in the front-rear direction beyond the end surface 26D.

As shown in FIG. 26, the guide portion 256D of the present modification is oblique to both the front-rear direction and the up-down direction. The guide portion 256D is located between the plane portion 257 and the first receiving portion 252D in the up-down direction. The guide portion 256D is located above the plane portion 257 in the up-down direction. The guide portion 256D is located below the first receiving portion 252D in the up-down direction. As shown in FIG. 25, the guide portion 256D is located below a center hole 29 in the up-down direction.

Referring to FIG. 26, the first stopping portions 258 of the present modification correspond to the second receiving portions 254D, respectively. Each of the first stopping portions 258 is located below the corresponding second receiving portion 254D in the up-down direction. Each of the first stopping portions 258 faces upward in the up-down direction. Each of the first stopping portions 258 is a surface perpendicular to the up-down direction. The first stopping portion 258 is located below the second stopping portion 259 in the up-down direction.

Referring to FIG. 26, the second stopping portions 259 of the present modification correspond to the second receiving portions 254D, respectively. Each of the second stopping portions 259 is located above the corresponding second receiving portion 254D in the up-down direction. Each of the second stopping portions 259 faces downward in the up-down direction. Each of the second stopping portions 259 is a surface perpendicular to the up-down direction. The second stopping portion 259 is located above the first stopping portion 258 in the up-down direction.

As shown in FIGS. 23 and 25, the fixed member 40D has a main portion 401B, a first contact portion 402B, two spring portions 404, two second contact portions 405, two first stopped portions 408 and two second stopped portions 409. The main portion 401B, the first contact portion 402B, the spring portion 404 and the second contact portion 405 of the present modification have configurations same as those of the main portion 401B, the first contact portion 402B, the spring portion 404 and the second contact portion 405 of the fixed member 40B of the second modification. Accordingly, a detailed description thereabout is omitted. The second contact portions 405 correspond to the first stopping portions 258, respectively. The second contact portions 405 correspond to the second stopping portions 259, respectively.

Referring to FIGS. 24 and 25, the guide portion 256D guides the first contact portion 402B to the first receiving portion 252D when the fixed member 40D is attached to the coaxial connector 20D.

As shown in FIG. 24, each of protrusions 403B of the first contact portion 402B is in contact with the first receiving portion 252D under the connected state. In other words, each of the protrusions 403B is electrically connected to the first receiving portion 252D of the flange portion 25D under the connected state. Referring to FIGS. 24 and 25, each of the protrusions 403B is located between two projecting portions 27 in the lateral direction under the connected state. The two protrusions 403B is located at opposite sides, respectively, of the contact portion 214 of the center terminal 21 in the lateral direction under the connected state. Each of the protrusions 403B is located in the vicinity of the contact portion 214 of the center terminal 21 under the connected state.

As shown in FIG. 25, the fixed member 40D has a first distance between the second contact portion 405 and the first contact portion 402B in the front-rear direction when the fixed member 40D is viewed alone. In other words, the fixed member 40D has the first distance between the second contact portion 405 and the first contact portion 402B in the front-rear direction under an initial state where the spring portion 404 is not resiliently deformed. Referring to FIGS. 25 and 26, the first distance is smaller than the second distance D2. Accordingly, referring to FIGS. 23 and 24, under the connected state, the flange portion 25D is sandwiched between the first contact portion 402B and the second contact portion 405 of the fixed member 40D via the first receiving portion 252D and the second receiving portion 254D while the spring portion 404 is resiliently deformed.

Referring to FIG. 23, the two spring portions 404 press the two second contact portions 405 against the two second receiving portions 254D, respectively, under the connected state. More specifically, under the connected state, the spring portion 404 presses the second contact portion 405 against the second receiving portion 254D while the second contact portion 405 receives reaction force from the second receiving portion 254D by the pressing of the spring portion 404. Referring to FIG. 24, under the connected state, each of the protrusions 403B of the first contact portion 402B is pressed against the first receiving portion 252D along the front-rear direction by the reaction force. Accordingly, the connector assembly 12D of the present modification is also configured so that the fixed member 40D is securely connected to the outer terminal 24D of the coaxial connector 20D. Thus, a ground layer 78A of the substrate 16 is electrically connected to the first receiving portion 252D of the flange portion 25D of the outer terminal 24D via the fixed member 40D in a highly reliable manner when the connector assembly 12D of the present modification is connected to the substrate 16. That is, in the connector assembly 12D of the present modification, the outer terminal 24D of the coaxial connector 20D of the connector assembly 12D can be stably connected to the ground layer 78A of the substrate 16 and this can securely reduce reflection characteristics of signals propagating between the substrate 16 and the connector assembly 12D.

As described above, the first contact portion 402B, which is located in the vicinity of the contact portion 214 of the center terminal 21 of the coaxial connector 20D, is pressed against the first receiving portion 252D along the front-rear direction under the connected state. This enables the fixed member 40D to be always in contact with the flange portion 25D at the vicinity of the contact portion 214 of the center terminal 21 of the coaxial connector 20D under the connected state. Accordingly, similar to the second modification, the connector assembly 12D of the present modification can securely reduce reflection characteristics of signals, which propagate between the substrate 16 and the connector assembly 12D, under connected state even if, for example, contact force between the first contact portion 402B and the first receiving portion 252D is not large.

As shown in FIG. 25, the first stopped portions 408 of the present modification correspond to the spring portions 404, respectively. Each of the first stopped portions 408 is located at an inner end of a second portion 4042 of the corresponding spring portions 404 in the lateral direction. The first stopped portion 408 faces downward in the up-down direction.

Referring to FIG. 23, the second stopped portions 409 of the present modification correspond to the spring portions 404, respectively. Each of the second stopped portions 409 is located at the inner end of the second portion 4042 of the corresponding spring portions 404 in the lateral direction. The second stopped portion 409 faces upward in the up-down direction.

Referring to FIGS. 24 and 25, under the connected state, the two fixing members 60 are fixed to the two projecting portions 27 of the outer terminal 24D through two passing holes 72, respectively, of the substrate 16 while the two fixing members 60 press the fixed member 40D against the ground layer 78A of the substrate 16 so that the predetermined plane becomes perpendicular to the up-down direction.

Referring to FIG. 27, the fixed member 40D of the present modification can take a temporary assembled state where the fixed member 40D is temporary assembled to the coaxial connector 20D. Specifically, referring to FIGS. 25 and 27, the fixed member 40D is attached to the coaxial connector 20D as follows: the spring portion 404 is resilient deformed; the second contact portion 405 is located between the corresponding first stopping portion 258 and the corresponding second stopping portion 259; and each of the protrusions 403B is in contact with the guide portion 256D. Accordingly, the coaxial connector 20D and the fixed member 40D change their state into the temporary assembled state shown in FIG. 27.

In the temporary assembled state, the first stopped portion 408 of the fixed member 40D is in contact with the first stopping portion 258 of the coaxial connector 20D while each of the protrusions 403B of the fixed member 40D is in contact with the guide portion 256D. Additionally, even in a case where the coaxial connector 20D is turned up-side down under the temporary assembled state, the second stopped portion 409 (see FIG. 23) of the fixed member 40D is brought into contact with the second stopping portion 259 of the coaxial connector 20D while each of the protrusions 403B of the fixed member 40D is brought into contact with the plane portion 257 of the flange portion 25D. Thus, the fixed member 40D is prevented from falling off from the coaxial connector 20D in this case. Consequently, an assembler can transport a set of the fixed member 40D and the coaxial connector 20D in the temporary assembled state.

### (Fifth Modification)

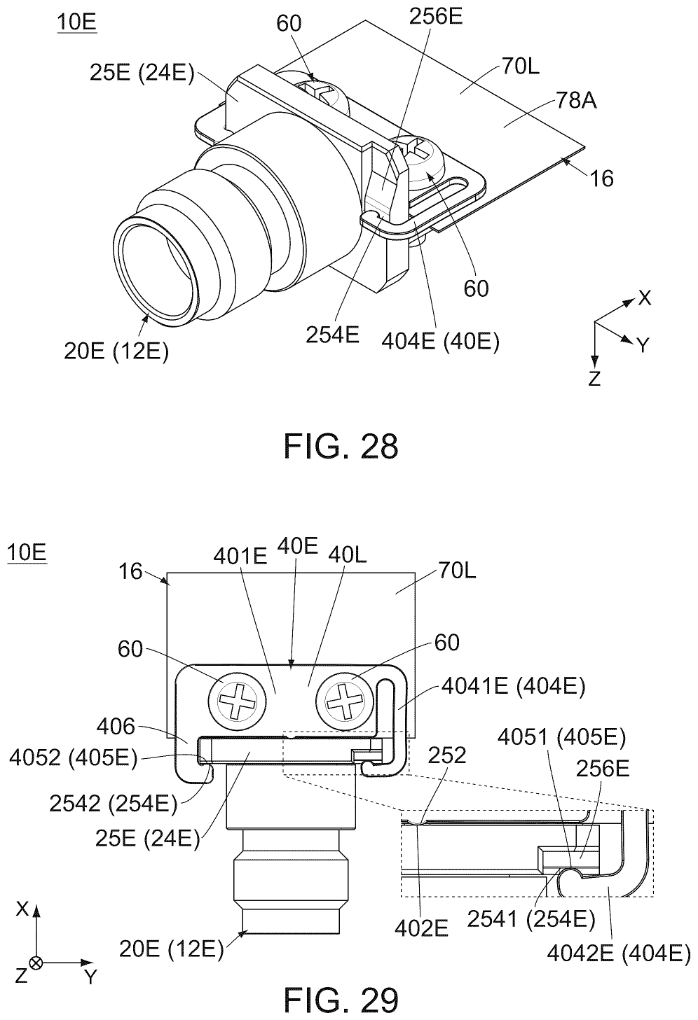

As shown in FIG. 28, a structure 10E according to a fifth modification comprises a connector assembly 12E and a substrate 16. The substrate 16 of the present modification has a configuration same as that of the substrate 16 of the aforementioned embodiment. Accordingly, a detailed description thereabout is omitted. The connector assembly 12E is configured to be connected to the substrate 16 similarly to the connector assembly 12.

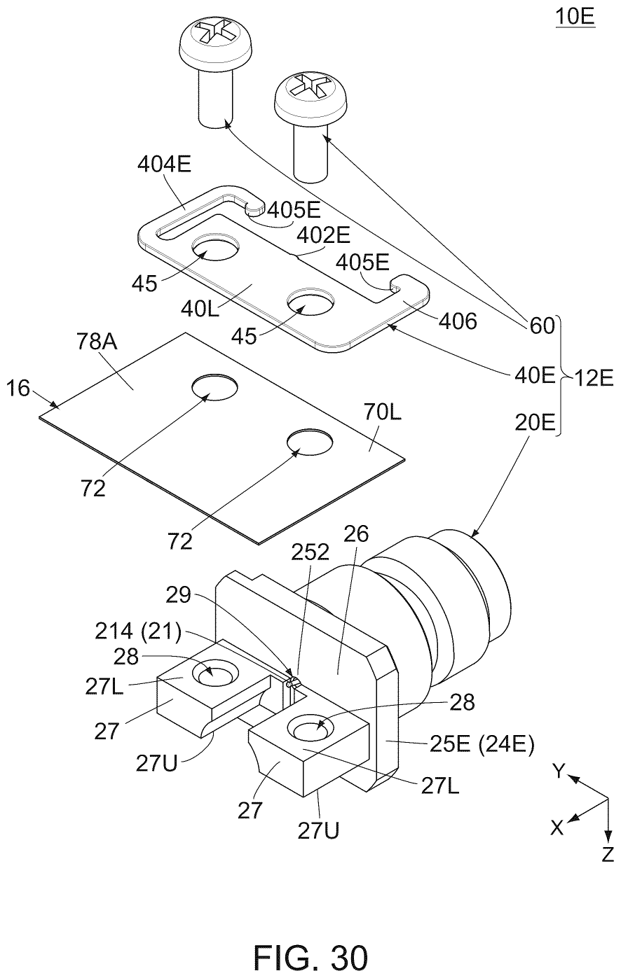

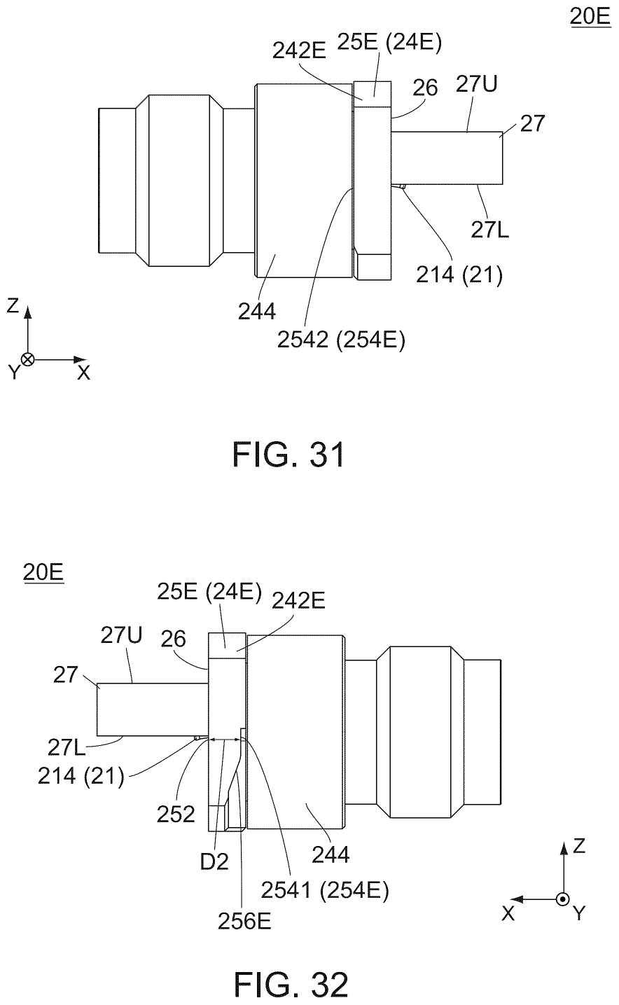

As shown in FIG. 30, the connector assembly 12E of the present modification comprises a coaxial connector 20E, a fixed member 40E and two fixing members 60. The fixing member 60 of the present modification has a configuration same as that of the fixing member 60 of the aforementioned embodiment. Accordingly, a detailed description thereabout is omitted.

Referring to FIG. 30, the coaxial connector 20E of the present modification comprises a center terminal 21 made of conductor, an insulation member (not shown) made of insulator and an outer terminal 24E made of conductor. The center terminal 21 and the insulation member of the present modification have configurations same as those of the center terminal 21 and the insulation member 22 of the aforementioned embodiment. Accordingly, a detailed description thereabout is omitted.

As shown in FIG. 32, the outer terminal 24E of the present modification comprises a front conductive member 242E and a rear conductive member 244. The rear conductive member 244 of the present modification has a configuration same as that of the rear conductive member 244 of the aforementioned embodiment. Accordingly, a detailed description thereabout is omitted.

As shown in FIG. 30, the outer terminal 24E of the present modification has a flange portion 25E and two projecting portions 27. The projecting portion 27 of the present modification has a configuration same as that of the projecting portion 27 of the aforementioned embodiment. Accordingly, a detailed description thereabout is omitted.

Referring to FIG. 32, the flange portion 25E of the present modification has a first receiving portion 252 and two second receiving portions 254E. The first receiving portion 252 of the present modification has a configuration same as that of the first receiving portion 252 of the aforementioned embodiment. Accordingly, a detailed description thereabout is omitted.

As shown in FIG. 29, each of the two second receiving portions 254E faces rearward in the front-rear direction. However, the present invention is not limited thereto. The second receiving portion 254E may face rearward in the front-rear direction and outward in the lateral direction. In other words, each of the two second receiving portions 254E should face at least rearward in the front-rear direction. The second receiving portions 254E are located at opposite ends, respectively, of the flange portion 25E in the lateral direction.

As shown in FIG. 29, the first receiving portion 252 is located forward of any of the second receiving portions 254E in the front-rear direction. However, the present invention is not limited thereto. The first receiving portion 252 may be located rearward of the second receiving portion 254E in the front-rear direction, provided that the first receiving portion 252 faces forward while the second receiving portion 254E faces at least rearward. If the first receiving portion 252 and the second receiving portions 254E are configured similar to the present modification, the flange portion 25E can have a reduced size in the front-rear direction. Accordingly, the first receiving portion 252 and the second receiving portions 254E of the present modification are more preferable.

As shown in FIG. 29, the two second receiving portions 254E include a second main receiving portion 2541 and a second auxiliary receiving portion 2542.

As shown in FIG. 29, the second main receiving portion 2541 is located at an end portion of the flange portion 25E in the lateral direction. Specifically, the second main receiving portion 2541 is located at a right end of the flange portion 25E in the right-left direction. The second main receiving portion 2541 is located forward of the second auxiliary receiving portion 2542 in the front-rear direction. As shown in FIG. 32, the flange portion 25E has a second distance D2 between the first receiving portion 252 and the second main receiving portion 2541 in the front-rear direction. In other words, the flange portion 25E has the second distance D2 between the first receiving portion 252 and the second receiving portion 254E in the front-rear direction.

As shown in FIG. 29, the second auxiliary receiving portion 2542 is located at the other end portion of the flange portion 25E in the lateral direction. Specifically, the second auxiliary receiving portion 2542 is located at a left end of the flange portion 25E in the right-left direction. The second auxiliary receiving portion 2542 is located rearward of the second main receiving portion 2541 in the front-rear direction.

As shown in FIG. 32, the flange portion 25E of the present modification has a guide portions 256E. The guide portion 256E is oblique to both the front-rear direction and the up-down direction. The guide portion 256E is located below the second main receiving portion 2541 in the up-down direction.

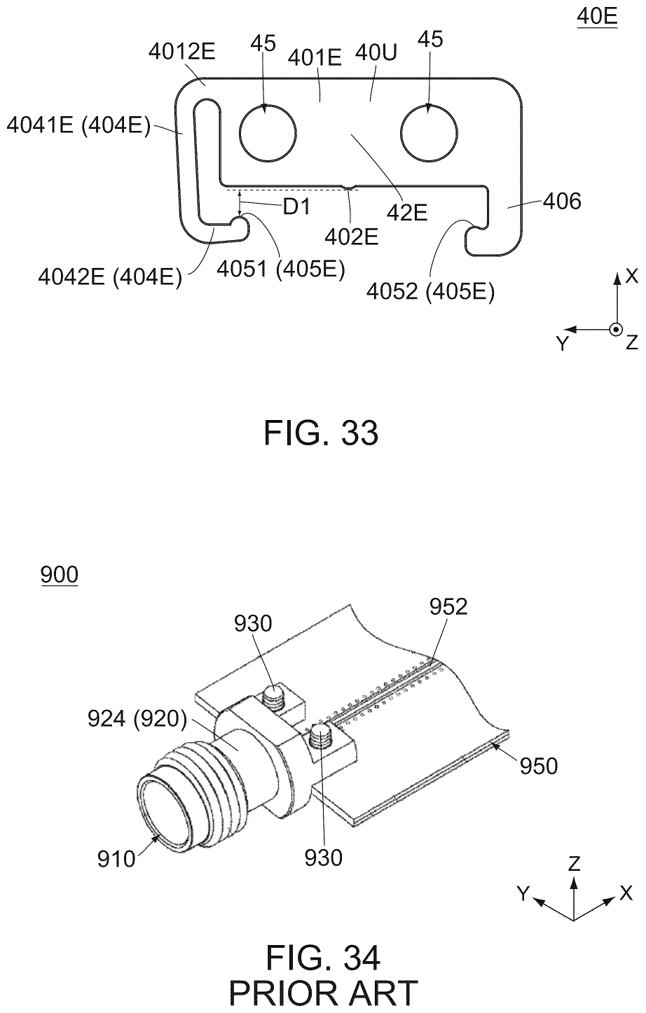

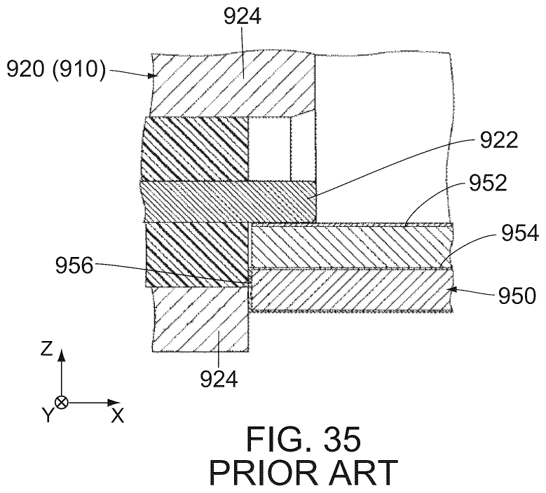

As shown in FIG. 30, the fixed member 40E of the present modification has a flat-plate shape. As shown in FIGS. 30 and 33, the fixed member 40E has an upper surface 40U and a lower surface 40L. The fixed member 40E is made of metal. As shown in FIG. 28, the fixed member 40E is located below the substrate 16 in the up-down direction under a connected state where the connector assembly 12E is connected to the substrate 16. The fixed member 40E is in contact with a ground layer 78A of the substrate 16 under the connected state.

As shown in FIG. 33, the fixed member 40E of the present modification has a main portion 401E, a first contact portion 402E, a spring portion 404E, a supporting portion 406 and two second contact portions 405E. The first contact portion 402E is located in the vicinity of a contact portion 214 of the center terminal 21 under the connected state. The first contact portion 402E of the present modification has a configuration same as that of the first contact portion 402A of the fixed member 40A of the first modification. Accordingly, a detailed description thereabout is omitted.

As shown in FIG. 33, the main portion 401E of the present modification extends in a predetermined plane. In detail, the main portion 401E wholly extends in the predetermined plane. However, the present invention is not limited thereto. Specifically, a part of the main portion 401E should extend in the predetermined plane. In other words, the main portion 401E should mainly extend in the predetermined plane. The main portion 401E has an extending portions 4012E. The extending portion 4012E is located at an end portion of the main portion 401E in the lateral direction. Specifically, the extending portion 4012E is located at a right end of the main portion 401E in the right-left direction.

As shown in FIG. 33, the spring portion 404E of the present modification extends from the main portion 401E and is resiliently deformable. The spring portion 404E extends rearward in the front-rear direction from the main portion 401E. The spring portion 404E has a first portion 4041E and a second portion 4042E.

As shown in FIG. 33, the first portion 4041E of the present modification extends in the front-rear direction. Specifically, the first portion 4041E extends mainly in the front-rear direction. The first portion 4041E extends rearward in the front-rear direction and inward in the lateral direction from the main portion 401E when the fixed member 40E is viewed alone. Specifically, the first portion 4041E extends rearward in the front-rear direction and inward in the lateral direction from the extending portion 4012E of the main portion 401E when the fixed member 40E is viewed alone.

As shown in FIG. 33, the second portion 4042E of the present modification extends in a direction intersecting with the front-rear direction from the first portion 4041E. Specifically, the second portion 4042E extends inward in the lateral direction perpendicular to the front-rear direction from the first portion 4041E.

As shown in FIG. 33, the supporting portion 406 of the present modification extends from the main portion 401E. Specifically, the supporting portion 406 extends rearward in the front-rear direction from a left end of the main portion 401E and is bent so that it extends inward in the lateral direction.

As shown in FIG. 33, the two second contact portions 405E of the present modification are apart from each other in the lateral direction. As shown in FIG. 29, the second contact portions 405E are in contact with the second receiving portions 254E, respectively, under the connected state. Under the connected state, the second contact portion 405E of the fixed member 40E made of metal is electrically connected to the second receiving portion 254E of the flange portion 25E made of metal. However, the present invention is not limited thereto. Specifically, the second contact portion 405E and the second receiving portion 254E may not be electrically connected to each other under connected state.

As shown in FIG. 33, the two second contact portions 405E include a second main contact portion 4051 and a second auxiliary contact portion 4052.

As shown in FIG. 33, the second main contact portion 4051 is located in the vicinity of an inner end of the second portion 4042E in the lateral direction. The second main contact portion 4051 is located rightward of the second auxiliary contact portion 4052 in the right-left direction. The spring portion 404E supports the second main contact portion 4051. Accordingly, the second main contact portion 4051 is movable in the predetermined plane. Referring to FIG. 29, the guide portion 256E guides the second main contact portion 4051 to the second main receiving portion 2541 when the fixed member 40E is attached to the coaxial connector 20E. Under the connected state, the second main contact portion 4051 is in contact with the second main receiving portion 2541.

As shown in FIG. 33, the second auxiliary contact portion 4052 is located in the vicinity of an inner end of the supporting portion 406 in the lateral direction. The supporting portion 406 supports the second auxiliary contact portion 4052. The second auxiliary contact portion 4052 is located leftward of the second main contact portion 4051 in the right-left direction. The second auxiliary contact portion 4052 is located around a left end of the fixed member 40E in the right-left direction. As shown in FIG. 29, the second auxiliary contact portion 4052 is in contact with the second auxiliary receiving portion 2542 under the connected state. Referring to FIGS. 32 and 33, the fixed member 40E has a distance between the second auxiliary contact portion 4052 and the first contact portion 402E in the front-rear direction when the fixed member 40E is viewed alone, and the distance is approximately equal to the second distance D2.

As shown in FIG. 33, the fixed member 40E has a first distance D1 between the second main contact portion 4051 and the first contact portion 402E in the front-rear direction when the fixed member 40E is viewed alone. In other words, the fixed member 40E has the first distance D1 between the second contact portion 405E and the first contact portion 402E in the front-rear direction when the fixed member 40E is viewed alone. The fixed member 40E has the first distance D1 between the second main contact portion 4051 and the first contact portion 402E in the front-rear direction under an initial state where the spring portion 404E is not resiliently deformed. Referring to FIGS. 32 and 33, the first distance D1 is smaller than the second distance D2. Accordingly, under the connected state, the flange portion 25E is sandwiched between the first contact portion 402E and the second main contact portion 4051 of the fixed member 40E via the first receiving portion 252 and the second main receiving portion 2541 while the spring portion 404E is resiliently deformed.

Referring to FIG. 29, under the connected state, the spring portion 404E presses the second main contact portion 4051 against the second main receiving portion 2541 while the second main contact portion 4051 receives reaction force from the second main receiving portion 2541 by the pressing of the spring portion 404E. Under the connected state, the first contact portion 402E is pressed against the first receiving portion 252 along the front-rear direction by the reaction force. Accordingly, the connector assembly 12E of the present modification is configured so that the fixed member 40E is securely connected to the outer terminal 24E of the coaxial connector 20E. Thus, the ground layer 78A of the substrate 16 is electrically connected to the first receiving portion 252 of the flange portion 25E of the outer terminal 24E via the fixed member 40E in a highly reliable manner when the connector assembly 12E of the present modification is connected to the substrate 16. That is, in the connector assembly 12E of the present modification, the outer terminal 24E of the coaxial connector 20E of the connector assembly 12E can be stably connected to the ground layer 78A of the substrate 16 and this can securely reduce reflection characteristics of signals propagating between the substrate 16 and the connector assembly 12E.

As described above, the first contact portion 402E, which is located in the vicinity of the contact portion 214 of the center terminal 21 of the coaxial connector 20E, is pressed against the first receiving portion 252 along the front-rear direction under the connected state. This enables the fixed member 40E to be always in contact with the flange portion 25E at the vicinity of the contact portion 214 of the center terminal 21 of the coaxial connector 20E under the connected state. Accordingly, similar to the first modification, the connector assembly 12E of the present modification can securely reduce reflection characteristics of signals, which propagate between the substrate 16 and the connector assembly 12E, under connected state even if, for example, contact force between the first contact portion 402E and the first receiving portion 252 is not large.

As shown in FIG. 33, the fixed member 40E has a pressed portion 42E. As described later, the pressed portion 42E is a part which is configured to be pressed against the substrate 16 under the connected state (see FIG. 29). According to the present modification, a middle part of the upper surface 40U in the lateral direction mainly works as the pressed portion 42E.

Referring to FIG. 29, the connector assembly 12E of the present modification is configured so that the second auxiliary receiving portion 2542 is located at the left end of the flange portion 25E while the second auxiliary contact portion 4052 supported by the supporting portion 406 is located around the left end of the fixed member 40E. When one of the fixing members 60, which are right-hand screws 60, is screwed into the screw hole 28 (see FIG. 30), the fixed member 40E receives force which urges the fixed member 40E to be rotated clockwise when the fixed member 40E is viewed from below. In the connector assembly 12E of the present modification, the second auxiliary receiving portion 2542 and the second auxiliary contact portion 4052 are arranged as described above. Accordingly, the second auxiliary receiving portion 2542, with which the second auxiliary contact portion 4052 is in contact, receives the force when the one of the fixing members 60 is screwed into the screw hole 28. This can prevent the rotation of the fixed member 400E relative to the flange portion 25E.

Although the specific explanation about the present invention is made above referring to the embodiments, the present invention is not limited thereto and is susceptible to various modifications and alternative forms.

While there has been described what is believed to be the preferred embodiment of the invention, those skilled in the art will recognize that other and further modifications may be made thereto without departing from the spirit of the invention, and it is intended to claim all such embodiments that fall within the true scope of the invention.

What is claimed is:

1. A connector assembly configured to be connected to a substrate, wherein:
the substrate is formed with two passing holes, each of the passing holes passing through the substrate in an up-down direction, the substrate having an upper surface and a lower surface in the up-down direction, the upper surface of the substrate being formed with a signal line, the signal line being located between the two passing holes in a lateral direction perpendicular to the up-down direction, the lower surface of the substrate being formed with a ground layer;
the connector assembly comprises a coaxial connector, a fixed member and two fixing members;
the coaxial connector is configured to be attached to a distal end of a coaxial cable;
the coaxial connector comprises an outer terminal and a center terminal;
the outer terminal has a flange portion and two projecting portions;
the flange portion has a first receiving portion and two second receiving portions;
the first receiving portion faces forward in a front-rear direction perpendicular to both the up-down direction and the lateral direction;
each of the two second receiving portions faces at least rearward in the front-rear direction;
the two projecting portions are apart from each other in the lateral direction;
each of the two projecting portions extends forward in the front-rear direction from the flange portion;
the fixed member is made of metal;
the fixed member is located below the substrate in the up-down direction under a connected state where the connector assembly is connected to the substrate;
the ground layer of the substrate is electrically connected to the first receiving portion of the flange portion via the fixed member under the connected state;
the fixed member has a main portion, a first contact portion, at least one spring portion and two second contact portions;
the main portion extends in a predetermined plane;
the first contact portion is provided at the main portion;
the first contact portion is located, at least in part, between the two second contact portions;
the spring portion extends from the main portion and is resiliently deformable;
the two second contact portions are apart from each other in the lateral direction;
at least one of the two second contact portions is supported by the spring portion and is movable in the predetermined plane;
under the connected state, the spring portion presses the second contact portion against the second receiving portion while the second contact portion receives reaction force from the second receiving portion by the pressing of the spring portion;
the first contact portion is pressed against the first receiving portion along the front-rear direction by the reaction force under the connected state; and
under the connected state, the two fixing members are fixed to the two projecting portions of the outer terminal through the two passing holes, respectively, of the substrate while the two fixing members press the fixed member against the ground layer of the substrate so that the predetermined plane becomes perpendicular to the up-down direction.

2. The connector assembly as recited in claim 1, wherein the first receiving portion is located forward of any of the second receiving portions in the front-rear direction.

3. The connector assembly as recited in claim 2, wherein:
the spring portion has a first portion and a second portion;
the first portion extends in the front-rear direction;
the second portion extends from the first portion in a direction intersecting with the front-rear direction;
the second contact portion is supported by the second portion;
the fixed member has a first distance between the at least one second contact portion and the first contact portion in the front-rear direction when the fixed member is viewed alone;
the flange portion has a second distance between the first receiving portion and the second receiving portion in the front-rear direction; and
the first distance is smaller than the second distance.

4. The connector assembly as recited in claim 1, wherein:
the fixed member has two of the spring portions;
the two spring portions support the two second contact portions, respectively; and
under the connected state, the two spring portions press the two second contact portions against the two second receiving portions, respectively.

5. The connector assembly as recited in claim 1, wherein:
the first contact portion comprises at least one protrusion;
the protrusion protrudes rearward in the front-rear direction from the main portion; and
the protrusion is located between the two projecting portions in the lateral direction under the connected state.

6. The connector assembly as recited in claim 1, wherein:
the fixed member is formed with two fixing holes;
each of the fixing holes passes through the fixed member in the up-down direction;
each of the fixing members is a screw;
each of the projecting portions is formed with a screw hole; and
each of the fixing members is screwed into the screw hole through the fixing hole of the fixed member and the passing hole of the substrate under the connected state.

7. The connector assembly as recited in claim 1, wherein:
the fixed member and the two fixing members are integrally formed with each other;
each of the fixing members is a press-fit portion;
each of the projecting portions is formed with a press-fit hole; and
each of the press-fit portions is press-fit into the press-fit hole through the passing hole of the substrate under the connected state.
